(19) United States
(12) Patent Application Publication
(10) Pub. No.: US 2014/0242914 A1
(43) Pub. Date: Aug. 28, 2014

(54) METHOD AND APPARATUS FOR CALIBRATING MULTIPLE ANTENNA ARRAYS

(71) Applicant: Samsung Electronics Co., Ltd., Suwon-si (KR)

(72) Inventor: Robert William Monroe, Melissa, TX (US)

(73) Assignee: Samsung Electronics Co., Ltd., Suwon-si (KR)

(21) Appl. No.: 14/184,240

(22) Filed: Feb. 19, 2014

Related U.S. Application Data
(60) Provisional application No. 61/768,216, filed on Feb. 22, 2013.

(51) Int. Cl. H04B 7/04

(52) U.S. Cl. CPC H04B 7/0413
USPC 455/63.4

(57) ABSTRACT

A method includes transmitting a calibration command to multiple antenna arrays. Each antenna array includes a plurality of antenna elements, a plurality of transmitter and receiver channels, and a calibration circuit comprising a calibration receiver and a calibration transmitter. The antenna arrays are connected to one another. The method also includes, for each pair of connected antenna arrays, calibrating the calibration circuits of the connected antenna arrays based on time delay differences and phase delay differences between the calibration receivers and the calibration transmitters in the pair of connected antenna arrays. In addition, the method includes calibrating the antenna elements of each antenna array using the calibrated calibration circuits.

### CROSS-REFERENCE TO RELATED APPLICATION AND CLAIM OF PRIORITY

The present application claims priority under 35 U.S.C. §119(e) to U.S. Provisional Patent Application Ser. No. 61/768,216 filed on Feb. 22, 2013 and entitled “MIMO CALIBRATION SYSTEM FOR A PLURALITY OF BEAMFORMING ANTENNA ARRAYS”. The above-identified provisional patent document is hereby incorporated by reference in its entirety.

### TECHNICAL FIELD

The present application relates generally to the calibration of multiple antenna arrays supporting multiple input, multiple output (MIMO) and/or beamforming.

### BACKGROUND

The dominant cellular network standard today is Long Term Evolution (LTE), and LTE-Advanced (LTE-A) will continue this legacy into the foreseeable future. Both LTE and LTE-A support multiple input, multiple output (MIMO) antenna configurations and beamforming MIMO operations involve channel reciprocity in time division duplexing (TDD) applications, and an equalizer can be applied to each transmitter and receiver in order to flatten their amplitude responses and linearize (straighten) their phase responses. Beamforming operations involve calculation of the angle or direction of arrival and the angle or direction of departure. A known reference plane at an antenna port of a transmitter is therefore used, where the transmitter's modulation envelope and phase are exactly aligned between all transmit channels. A known reference plane at an analog-to-digital converter (ADC) of a receiver is also used, where the receiver's modulation envelope and phase are exactly aligned between all receive channels.

MIMO and beamforming typically require two or more antennas, and advanced systems can have 4, 8, 16, 32, or more antennas. Beyond 16 or 32 antennas, it often becomes impractical to house all antenna elements in a single package due to size and manufacturability issues. For example, patch antennas fabricated on printed circuit boards (PCBs) typically require a ½ wavelength (λ/2) spacing between elements. This can drive PCB sizes beyond those that are manufacturable and sturdy enough to withstand flexing, warping, and handling. As a result, MIMO and beamforming arrays often have to be implemented using multiple independent PCBs or antenna arrays. Similarly, a transceiver that provides radio functions like transmission and reception of radio signals (such as cellular signals) may often need to be implemented on multiple independent PCBs.

### SUMMARY

A method includes transmitting a calibration command to multiple antenna arrays. Each antenna array includes a plurality of antenna elements, a plurality of transmitter and receiver channels, and a calibration circuit having a calibration receiver and a calibration transmitter. The antenna arrays are connected to one another. The method also includes, for each pair of connected antenna arrays, calibrating the calibration circuits of the connected antenna arrays based on time delay differences and phase delay differences between the calibration receivers and the calibration transmitters in the pair of connected antenna arrays. In addition, the method includes calibrating the antenna elements of each antenna array using the calibrated calibration circuits.

A system includes multiple antenna arrays. Each antenna array includes a plurality of antenna elements, a plurality of transmitter and receiver channels, a calibration circuit having a calibration receiver and a calibration transmitter, and a controller. The controller is configured to calibrate the calibration circuit of the antenna array based on time delay differences and phase delay differences between the calibration receivers and the calibration transmitters in a pair of connected antenna arrays. The controller is also configured to calibrate the antenna elements of the antenna array using the calibrated calibration circuit of the antenna array.

An apparatus for use with multiple antenna arrays is provided. Each antenna array includes a plurality of antenna elements, a plurality of transmitter and receiver channels, and a calibration circuit having a calibration receiver and a calibration transmitter. The apparatus includes a controller configured to calibrate the calibration circuit of a first of the multiple antenna arrays based on time delay differences and phase delay differences between the calibration receivers and the calibration transmitters in a pair of connected antenna arrays including the first antenna array and a second antenna array. The controller is also configured to calibrate the antenna elements of the first antenna array using the calibrated calibration circuit of the first antenna array.

A method for aligning multiple transceivers connected to one another is provided. Each transceiver includes a transmitter and a receiver. The method includes transmitting an alignment command to the multiple transceivers. The method also includes, for each pair of connected transceivers, aligning calibration circuits of the connected transceivers based on time delay differences and phase delay differences between the receivers and the transmitters in the pair of connected transceivers. The time delay difference between the receivers in one pair of connected transceivers is determined as:

τ_{RX2}−τ_{RX1}=(B1−A1−D1+C1)/2

where:
A1=τ_{TX1}+τ_{d1}+τ_{RX1}
B1=τ_{TX1}+τ_{d2}+τ_{RX2}
C1=τ_{TX1}+τ_{d1}+τ_{RX2}
D1=τ_{TX2}+τ_{d2}±τ_{RX1}
   Here, τ_{TX1} and τ_{RX1} are time delays at the transmitter and the receiver, respectively, in a first of the connected transceivers. Also, τ_{TX2} and τ_{RX2} are time delays at the transmitter and the receiver, respectively, in a second of the connected transceivers. Further, τ_{d1} is a time delay between the transmitter and the receiver in the first transceiver, and τ_{d2} is a time delay between the transmitter in one of the connected transceivers and the receiver in another of the connected transceivers.

An apparatus for aligning multiple transceivers connected to one another is provided. Each transceiver includes a transmitter and a receiver. The apparatus includes a controller configured to transmit an alignment command to the multiple transceivers and, for each pair of connected transceivers, align calibration circuits of the connected transceivers based on time delay differences and phase delay differences between the receivers and the transmitters in the pair of connected transceivers. The controller is configured to determine the time delay difference between the receivers in one pair of connected transceivers as:

τ_{RX2}−τ_{RX1}=(B1−A1−D1+C1)/2

where:
A1=τ_{TX1}+τ_{d1}+τ_{RX1}
B1=τ_{TX1}+τ_{d2}+τ_{RX2}
C1=τ_{TX1}+τ_{d1}+τ_{RX2}
D1=τ_{TX2}+τ_{d2}+τ_{RX}
   Here, τ_{TX1} and τ_{RX1} are time delays at the transmitter and the receiver, respectively, in a first of the connected transceivers. Also, τ_{TX2} and τ_{RX2} are time delays at the transmitter and the receiver, respectively, in a second of the connected transceivers. Further, τ_{d1} is a time delay between the transmitter and the receiver in the first transceiver, and τ_{d2} is a time delay between the transmitter in one of the connected transceivers and the receiver in another of the connected transceivers.

A method for use with multiple antenna arrays is provided. Each antenna array includes a plurality of antenna elements, a plurality of transceivers, a clock recovery circuit, and a synchronization (sync) generator circuit. The method includes designating one of the antenna arrays as a master antenna array and at least one other of the antenna arrays as at least one slave antenna array. The method also includes enabling the clock recovery circuit and the sync generator circuit of the master antenna array and disabling the clock recovery circuits and the sync generator circuits of each slave antenna array. The method further includes injecting a clock signal recovered from the clock recovery circuit of the master antenna array into the master and at least one slave antenna arrays and injecting a sync signal generated from the sync generator circuit of the master antenna array into the master and at least one slave antenna arrays. Moreover, the method includes adjusting phases of the clock and sync signals arriving at each transceiver in the master antenna array such that the clock and sync signals arrive substantially edge-aligned at each transceiver of the master antenna array. In addition, the method includes, for each slave antenna array, adjusting phases of clock and sync signals arriving at each transceiver in the slave antenna array such that the clock and sync signals arrive substantially edge-aligned at each transceiver of the slave antenna array.

An apparatus for use with multiple antenna arrays is provided. Each antenna array includes a plurality of antenna elements, a plurality of transceivers, a clock recovery circuit, and a synchronization (sync) generator circuit. The apparatus includes a controller configured to designate one of the antenna arrays as a master antenna array and at least one other of the antenna arrays as at least one slave antenna array. The controller is also configured to enable the clock recovery circuit and the sync generator circuit of the master antenna array and disable the clock recovery circuits and the sync generator circuits of each slave antenna array. The controller is further configured to inject a clock signal recovered from the clock recovery circuit of the master antenna array into the master and at least one slave antenna arrays and inject a sync signal generated from the sync generator circuit of the master antenna array into the master and at least one slave antenna arrays. Moreover, the controller is configured to adjust phases of the clock and sync signals arriving at each transceiver in the master antenna array such that the clock and sync signals arrive substantially edge-aligned at each transceiver of the master antenna array. In addition, the controller is configured, for each slave antenna array, to adjust phases of clock and sync signals arriving at each transceiver in the slave antenna array such that the clock and sync signals arrive substantially edge-aligned at each transceiver of the slave antenna array.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example wireless network in accordance with this disclosure;

FIG. 2 illustrates an example eNodeB (eNB) in accordance with this disclosure;

FIG. 3 illustrates an example user equipment (UE) in accordance with this disclosure;

FIG. 4 illustrates an example two-by-two MIMO channel model with channels represented by matrices in accordance with this disclosure;

FIG. 5 illustrates an example algorithm that performs MIMO calibration or equalization in accordance with this disclosure;

FIG. 6A illustrates example incoming waveform at angle of arrival (AOA) θ_{A} and example phase and time delays that occur between antenna ports in a MIMO system in accordance with this disclosure;

FIG. 6B illustrates an example of finding the angle of arrival of an incoming waveform in a MIMO system in accordance with this disclosure;

FIGS. 7A and 7B illustrate example calibrated antenna arrays exhibiting envelope and phase alignment in accordance with this disclosure;

FIG. 8 illustrates an example single-board antenna array with a calibration circuit in accordance with this disclosure;

FIGS. 9A and 9B illustrate example single-board and multi-board antenna arrays in accordance with this disclosure;

FIGS. 10A through 10C illustrate example multi-board antenna arrays in accordance with this disclosure;

FIGS. 11A and 11B illustrate example single-board antenna arrays with transmitter and receiver functions in accordance with this disclosure;

FIG. 12 illustrates an example of two connected boards with their associated calibration circuits among a multi-board antenna array in accordance with this disclosure;

FIGS. 13A and 13B illustrate an example simplified calibration architecture for a two-board antenna array for deriving calibration equations in accordance with this disclosure;

FIG. 14 illustrates an example final simplified calibration architecture for a two-board antenna array in accordance with this disclosure;

FIGS. 15A and 15B illustrate an example calibration operation for time delays of multi-board calibration circuits in accordance with this disclosure;

FIG. 16 illustrates an example calibration operation for phase delays of multi-board calibration circuits in accordance with this disclosure;

FIGS. 17A through 17D illustrate example calibrations of delays and phases between calibration circuits of two connected boards of a multi-board antenna array in accordance with this disclosure;

FIG. 18 is an example flowchart for calibrating a multi-board antenna array in accordance with this disclosure;

FIG. 19 illustrates an example time and phase calibration procedure for a multi-board antenna array in accordance with this disclosure;

FIG. 20 illustrates an example system for self-calibrating two calibration receiver channels and two calibration transmitter channels in a single board of a multi-board antenna array in accordance with this disclosure;

FIG. 21 illustrates an example clock synchronization plane used to calibrate an antenna array in accordance with this disclosure;

FIG. 22A illustrates an example multi-board antenna array with a clock synchronization system in accordance with this disclosure;

FIG. 22B illustrates an example algorithm for achieving clock synchronization across multiple antenna arrays in accordance with this disclosure;

FIG. 23 illustrates an example multi-board antenna array equipped with a data transfer system in accordance with this disclosure; and

FIG. 24 illustrates an example flowchart describing calibration operations of multi-board antenna arrays in accordance with this disclosure.

### DETAILED DESCRIPTION

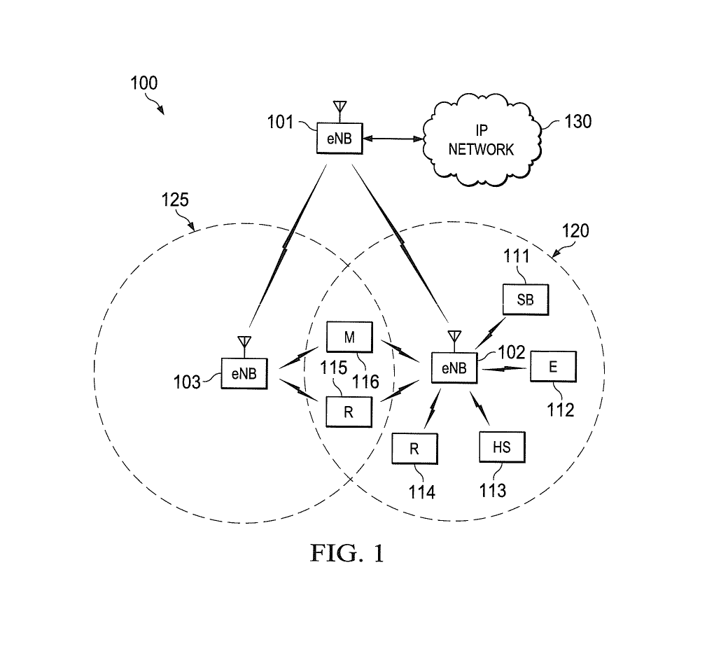

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, or other advanced wireless communication techniques.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, various component of the network 100, such as the eNBs 101-103 and/or the UEs 111-116, can include a mechanism for calibrating single-board or multi-board antenna arrays.

Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

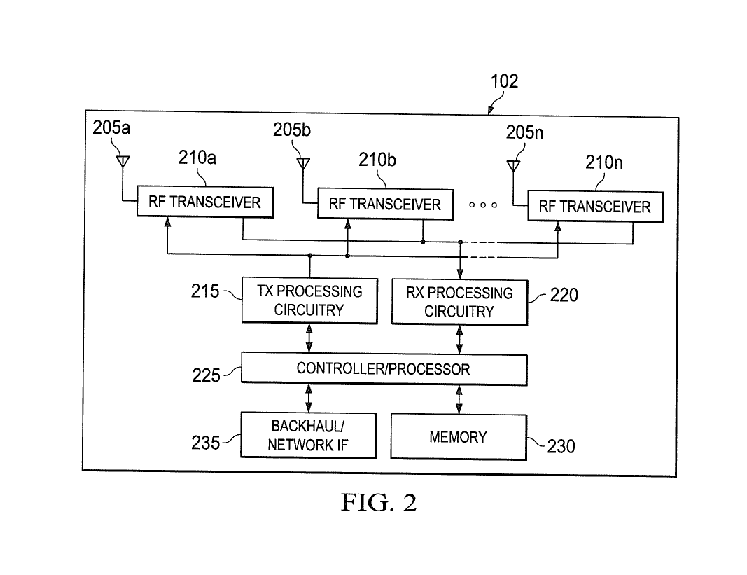

FIG. 2 illustrates an example eNB 102 according to this disclosure. The embodiment of the eNB 102 illustrated in FIG. 2 is for illustration only, and the eNBs 101 and 103 of FIG. 1 could have the same or similar configuration. However, eNBs come in a wide variety of configurations, and FIG. 2 does not limit the scope of this disclosure to any particular implementation of an eNB.

As shown in FIG. 2, the eNB 102 includes multiple antennas 205a-205n, multiple RF transceivers 210a-210n, transmit (TX) processing circuitry 215, and receive (RX) processing circuitry 220. The eNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the eNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the eNB 102 by the controller/processor 225. In some embodiments, the controller/processor 225 includes at least one microprocessor or microcontroller. The controller/processor 225 is also capable of executing programs and other processes resident in the memory 230, such as a basic OS. The controller/processor 225 can move data into or out of the memory 230 as required by an executing process.

The controller/processor 225 is also coupled to the backhaul or network interface 235. The backhaul or network interface 235 allows the eNB 102 to communicate with other devices or systems over a backhaul connection or over a network. The interface 235 could support communications over any suitable wired or wireless connection(s). For example, when the eNB 102 is implemented as part of a cellular communication system (such as one supporting 5G, LTE, or LTE-A), the interface 235 could allow the eNB 102 to communicate with other eNBs over a wired or wireless backhaul connection. When the eNB 102 is implemented as an access point, the interface 235 could allow the eNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of eNB 102, various changes may be made to FIG. 2. For example, the eNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the eNB 102 could include multiple instances of each (such as one per RF transceiver). Also, various components in FIG. 2 could be combined, further subdivided, or omitted and additional components could be added according to particular needs.

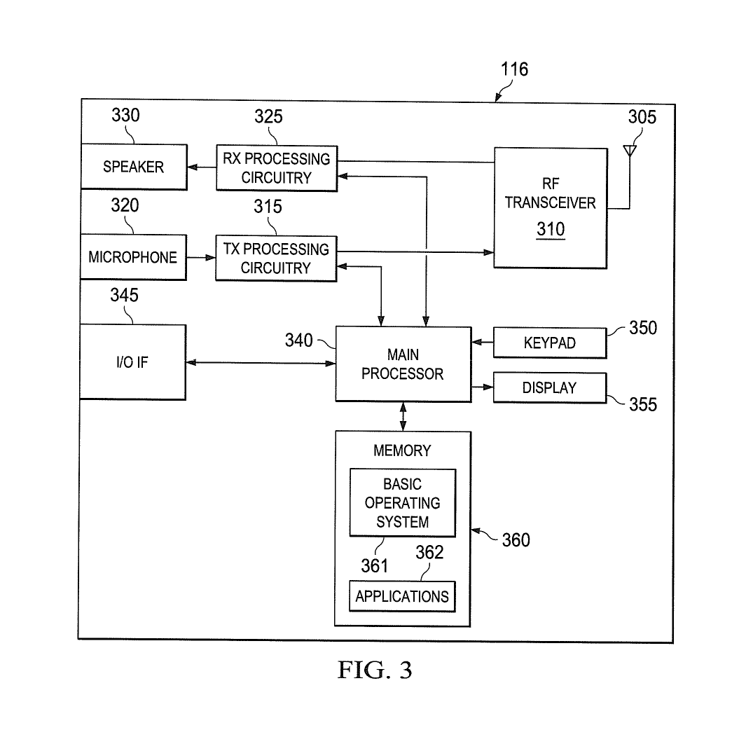

FIG. 3 illustrates an example UE 116 according to this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from eNBs or an operator. The main processor 340 is also coupled to the I/O interface 345, which provides the UE 116 with the ability to connect to other devices such as laptop computers and handheld computers. The I/O interface 345 is the communication path between these accessories and the main processor 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

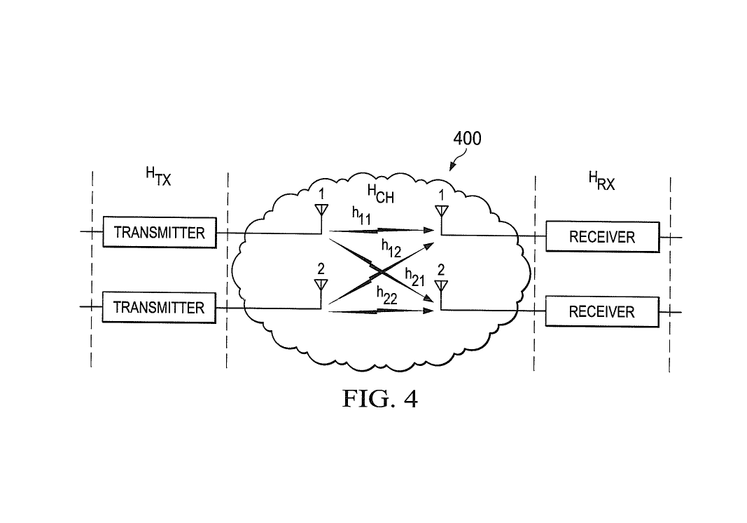

FIG. 4 illustrates an example two-by-two MIMO channel model 400 with channels represented by matrices in accordance with this disclosure. A wireless MIMO channel is modeled as a channel matrix H_{CH}, which is composed of direct components h₁₁ and h₂₂ and cross components h₁₂ and h₂₁. These matrix components are complex numbers that represent attenuation and phase shifts that occur in the channel. Transmitters and receivers also exhibit attenuation and phase shifts and can be modeled using matrices H_{TX} and H_{RX}. The matrices H_{TX} and H_{RX} can be multiplied with the channel matrix H_{CH} in order to calculate a total channel response. This can involve real-time measurements and calculations of H_{TX} and H_{RX} and real-time matrix manipulations that are costly in terms of processing resources and processing times.

It is desirable to “null out” the effects of H_{TX} and H_{RX} in order create a reciprocal channel such that H_{TX1}*H_{CH}*H_{RX1} H_{TX2}*H_{CH}*H_{RX2}. This allows a downlink channel estimation made by the UE receiver to be accurately used as the uplink channel estimate or vice-versa. Additionally, it can eliminate extra real-time overhead processing. If this can be done, it is possible to meet the conditions for linear distortion-free transmission. The amplitude response is desired to be flat versus frequency over a desired bandwidth, and the phase response is desired to be linear versus frequency over the desired bandwidth.

Unfortunately, transmitters and receivers have non-ideal amplitude and phase responses. This can be due to various factors, such as gain slopes from semiconductors, narrowband matching networks and narrowband components; gain and phase ripples from VSWR reflections in mismatched components; and gain and phase ripples from RF filters, anti-alias filters, image filters, and the like.

Correcting this is normally accomplished using a baseband equalizer with multiple taps to linearize the phase and flatten the amplitude response. This is termed MIMO calibration (equalization) and is the method used to null out the responses H_{TX1}, H_{RX1}, H_{TX2}, and H_{RX2} and make them equal to one. Equalization applied at both the UE and the eNB creates a new response Hₙᵤₗₗ=H_{TX1}=H_{RX1}=H_{TX2}=H_{RX2}, and the total channel response becomes:

Hₙᵤₗₗ*H_{CH}*Hₙᵤₗₗ=Hₙᵤₗₗ*H_{CH}*Hₙᵤₗₗ

H_{CH}=H_{CH}

H_{CH(DL)}=H_{CH(UL)}

After MIMO calibration (equalization), the total downlink channel response is equal to the total uplink channel response to create reciprocal wireless channels. As a result, a channel estimation performed on the uplink channel can be used confidently as the estimate for the downlink channel and vice-versa.

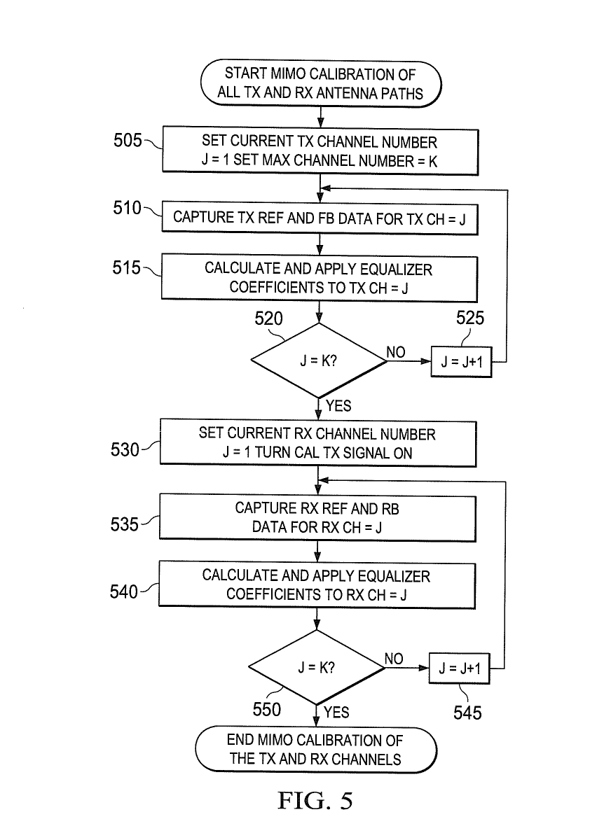

FIG. 5 illustrates an example algorithm that performs MIMO calibration or equalization in accordance with this disclosure. In step 505, default values are set. This could include setting the current transmitter channel J=1 and the maximum number of transmitter channels=K. In step 510, simultaneously capture a transmitter baseband input reference signal (REF) and a feedback signal (FB) from an output of a calibration receiver. In step 515, calculate equalizer coefficients used to flatten the amplitude response over the desired band and linearize (straighten) the phase response over the desired band. Various techniques could be used to accomplish this, such as a Least Mean Square (LMS) adaptive algorithm. The coefficients are loaded into the current channel's equalizer. In step 520, check to see if this is the last channel to be equalized. If not, increment J in step 525 and return to step 510. If J=K, all channels have been equalized, and the process moves on to receiver equalization.

In step 530, reset J=1, turn on a baseband waveform player, and play it into a calibration transmitter, which injects it into each receiver channel either selectively or all at once (depending on the algorithm used). In step 535, simultaneously capture a baseband receiver output feedback signal (FB) and a reference signal (FB) from the input of the calibration transmitter. In step 540, calculate equalizer coefficients used to flatten the amplitude response over the desired band and linearize (straighten) the phase response over the desired band. Again, various techniques can be used, such as an LMS adaptive algorithm. The coefficients are loaded into the current channel's equalizer. In step 550, check to see if this is the last channel to be equalized. If not, increment J at step 545 and return to step 535. If J=K, all channels have been equalized, and the equalization routine is terminated.

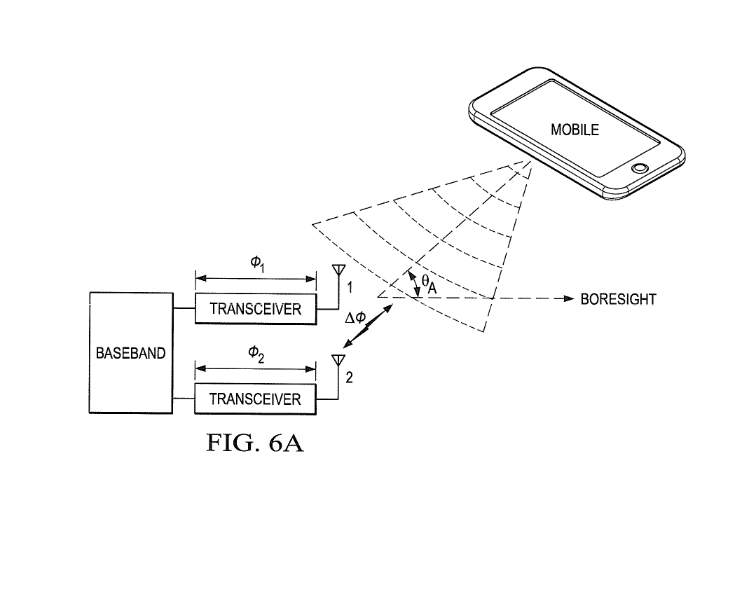

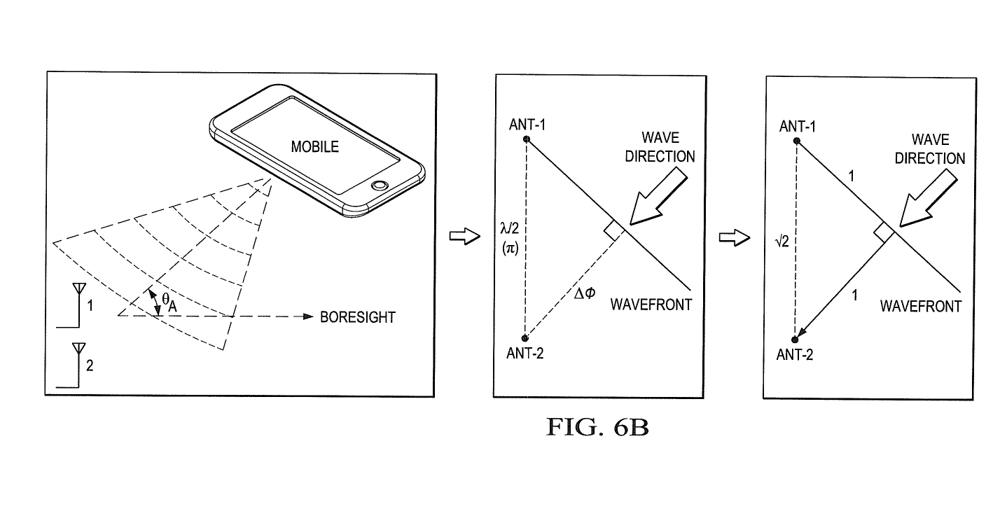

FIG. 6A illustrates example incoming waveform at angle of arrival (AOA) θ_{A} and example phase and time delays that occur between antenna ports in a MIMO system and FIG. 6B illustrates an example of finding the angle of arrival of an incoming waveform in a MIMO system in accordance with this disclosure. As shown in FIG. 6A, as a signal moves away from a source antenna, its wavefront flattens out in the far-field and impinges upon antenna-1 first and then hits antenna-2. Thus, alignment of RF carriers in phase and time between antenna ports can be needed whenever direction of arrival (DOA) and direction of departure (DOD) calculations are performed.

In FIGS. 6A and 6B, the goal is to measure the time difference and corresponding phase difference Δφ between when the wavefront hits two or more antennas in order to accurately calculate the signal's angle of arrival θ_{A} and consequently the direction of arrival. This allows a device to transmit signals with an accurate direction of departure based on the measured Δφ. The angle of arrival θ_{A} can be defined as

$${θ}_{A} = {sin}^{- 1} ( \frac{λ \cdot Δφ}{2 \cdot π \cdot d} ) ,$$

where λ represents the signal wavelength (or electrical length λ=360°=2π) at a center frequency f_{c}, Δφrepresents the phase difference between antennas at a specific AOA θ_{A}, and d represents the distance between antennas. In some embodiments, d equals λ/2 (180°=π), and the equation becomes

$${θ}_{A} = {sin}^{- 1} ( \frac{Δφ}{π} ) .$$

As an example, if the phase difference is measured to be Δφ=π/\sqrt{2} radians, the angle of arrival is then

$$\begin{matrix}{θ}_{A} = {sin}^{- 1} ( \frac{Δφ}{π} ) \\ = {sin}^{- 1} \frac{π / \sqrt{2}}{π} \\ = \frac{π}{4} \\ = 45 ° .\end{matrix}$$

This can be verified using similar triangles as shown in FIG. 6B. A 45° triangle has equal sides and a hypotenuse of \sqrt{2}. Equating d=λ/2=π and Δφ to the 45° triangle yields

$$\begin{matrix}\frac{π}{Δφ} = \frac{\sqrt{2}}{1} \to Δφ \\ = π / \sqrt{2} .\end{matrix}$$

With reference to the FIG. 6A, θ_{A} is the UE signal's angle of arrival, φ₁ is the phase of transceiver path-1, and φ₂ is the phase of transceiver path-2. As an example of incorrect AOA calculation due to phase mismatch between receiver paths, if the transceiver phase φ₁ equals 936° (1.0 nsec) and the transceiver phase φ₂ equals 982.8° (1.05 nsec), the delta of 0.05 nsec corresponds to a phase difference error A φₑ of 46.8° at 2600 MHz. If the angle of arrival θ_{A} equals 45°, the phase difference of the signals hitting the antennas can be Δφ₁₂=π/\sqrt{2}=2.221 radians=127.27°. The baseband reads a phase difference Δφₜₒₜ=(Δφ₁₂+Δφₑ)=(127.27°+46.8°=174° and an angle of arrival

$$\begin{matrix}{θ}_{A} = {sin}^{- 1} ( \frac{Δφ}{π} ) \\ = {sin}^{- 1} ( \frac{174 °}{180 °} ) \\ = 75.26 ° .\end{matrix}$$

This means the eNB calculation of the angle of arrival is in error by (75.26°−45°)=30.26°, and consequently an eNB could send signals in the wrong direction based on an incorrect θ_{A} calculation. Calibrating the phases between RX antenna channels and between TX antenna channels is therefore useful whenever determining the direction of arrival and direction of departure, such as in beamforming applications.

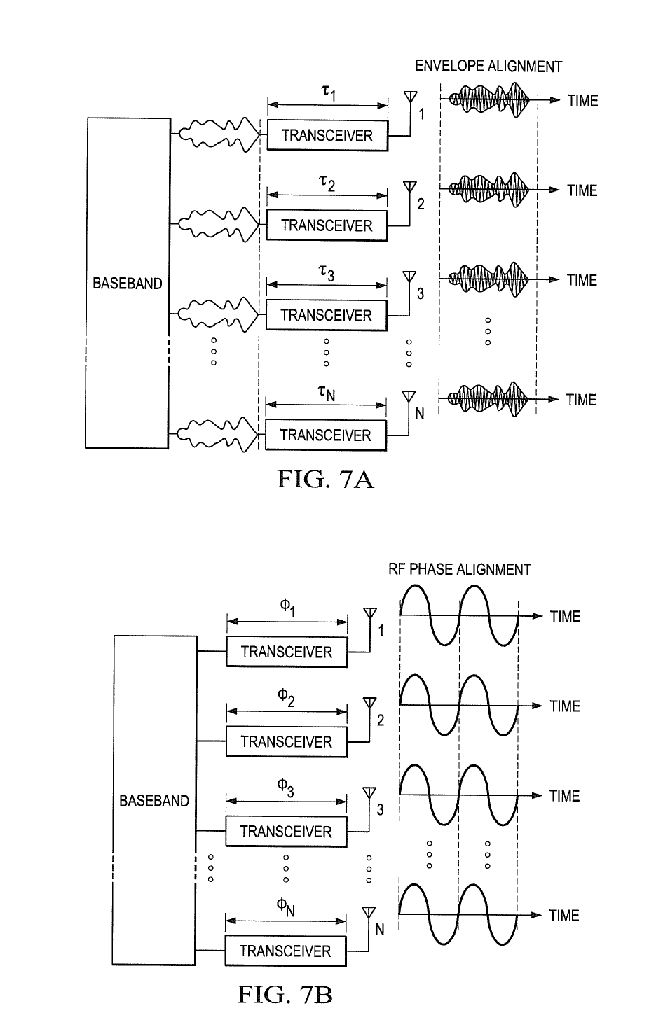

FIGS. 7A and 7B illustrate example calibrated antenna arrays exhibiting envelope and phase alignment in accordance with this disclosure. In particular, FIG. 7A illustrates a time delay-calibrated multi-board antenna array, and FIG. 7B illustrates a phase delay-calibrated multi-board antenna array. Each transceiver could have the same time delay and phase alignment so that baseband envelopes modulate onto a local oscillator (LO), and information will be aligned at the antenna. As a result, the time delays of the antenna paths can be aligned such that each channel's delay between baseband and antenna is the same: τ₁=T₂=T₃= . . . =TN. Likewise, carrier phases in each antenna path can be aligned so that each channel's phase between baseband and antenna is the same: φ₁=φ₂=φ₃= . . . =θ_{N}.

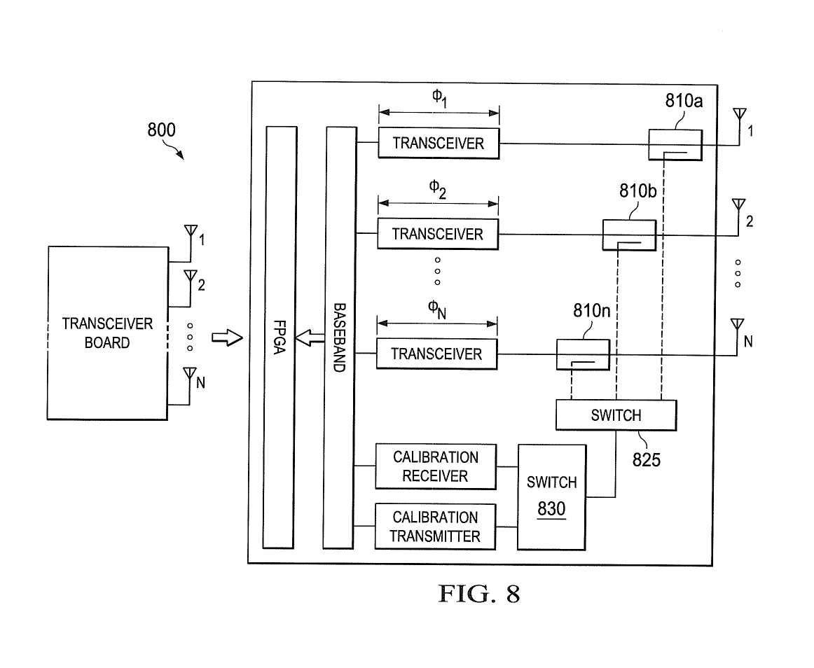

FIG. 8 illustrates an example single-board antenna array 800 with a calibration circuit in accordance with this disclosure. As shown in FIG. 8, couplers 810a-810n sample data from each transmit (TX) channel and provide feedback to switches 825-830, which selectively switch the sampled signal to a calibration receiver that converts the signal to baseband for further signal processing. A calibration transmitter sends a calibrating signal to the switches 825-830, which is consequently injected into couplers 810a-810n where it enters each receiver's RF front end and makes its way into the baseband for further processing. During transmit time, data is simultaneously captured at baseband prior to the analog/RF transmitter and at the calibration receiver. An algorithm processes the signals to determine the delay and phase of each channel. Similarly, during receive time, data is simultaneously captured at the calibration transmitter's baseband input and at each receiver's baseband in order to determine each receiver's delay and phase. The algorithm then aligns all of RX or TX channels to have the same time delay and phase in a single board by compensating for the measured differences in time and phase.

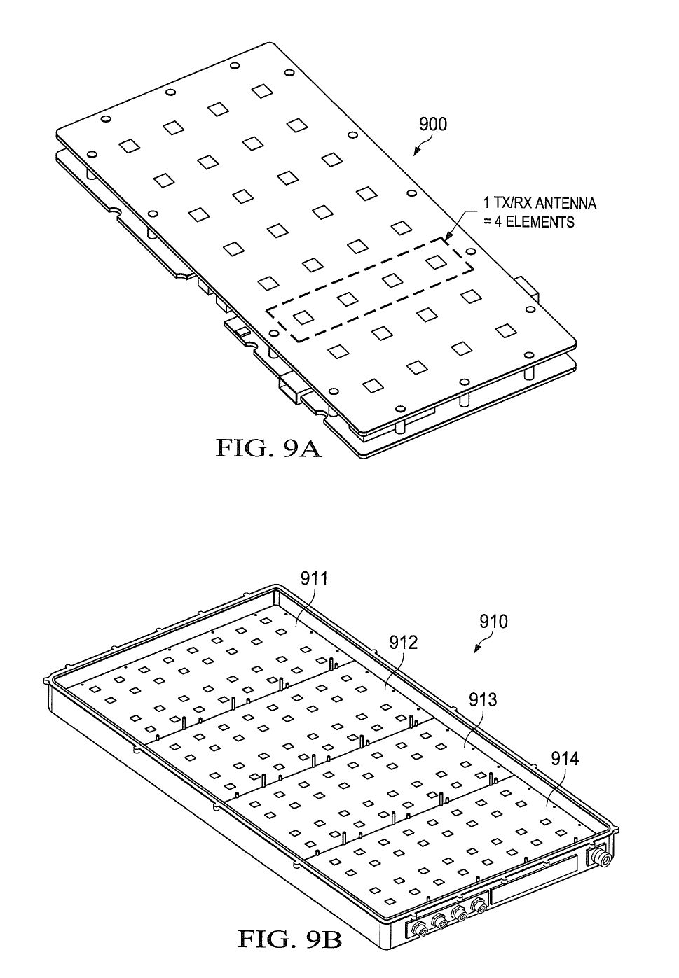

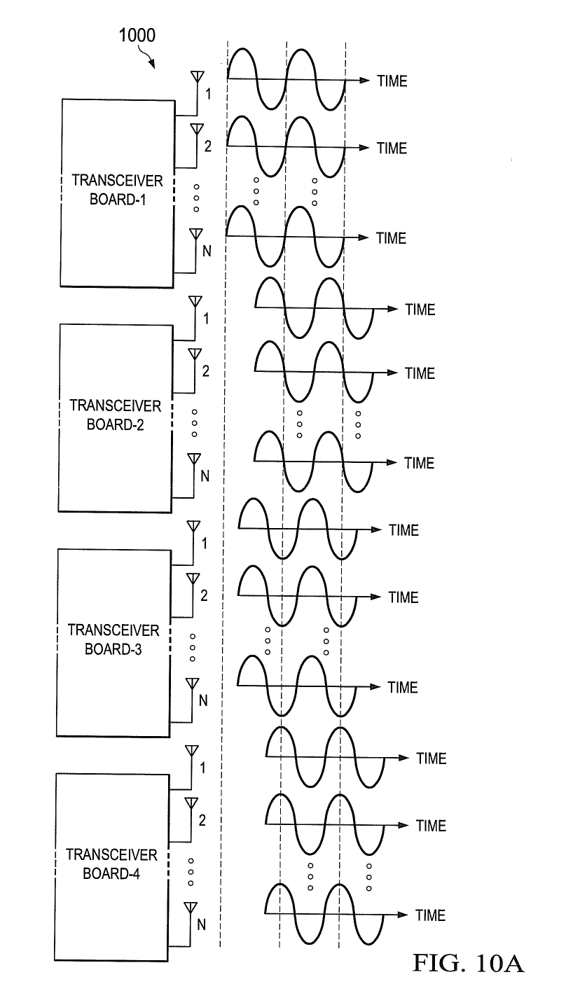

FIGS. 9A and 9B illustrate example single-board and multi-board antenna arrays in accordance with this disclosure. As shown in FIG. 9A, a single-board antenna array 900 includes N antennas directly coupled to N channel (CH) transceivers. In this example, the antenna array 900 includes eight antennas (four elements or patches per antenna) and mates directly to an eight-channel transceiver. This array 900 therefore represents an eight-channel transceiver with eight TX channels and eight RX channels. The TX and RX channels can be duplexed into eight antennas in an FDD system, or the TX and RX channels can be time-multiplexed into eight antennas using a Transmit/Receive (T/R) switch. As shown in FIG. 9B, a multi-board antenna array 910 can have up to N single boards, where N is a positive integer. In some embodiments, four boards 911-914 create a full array of 32 antennas, such as for a total of 128 patches (32×4 patches). Each antenna array has the same structure, includes a plurality of antennas and TX/RX channels, and is operated independently. In FIGS. 9A and 9B, each antenna array with a plurality of antennas and their TX/RX channels is implemented on the separate boards. Alternatively, in some embodiments, multiple antenna arrays can be implemented on one single board.

In some embodiments, an antenna array supporting MIMO and/or beamforming is implemented on multiple independent PCBs. Similarly, a transceiver PCB that provides radio functions can be implemented on multiple independent PCBs.

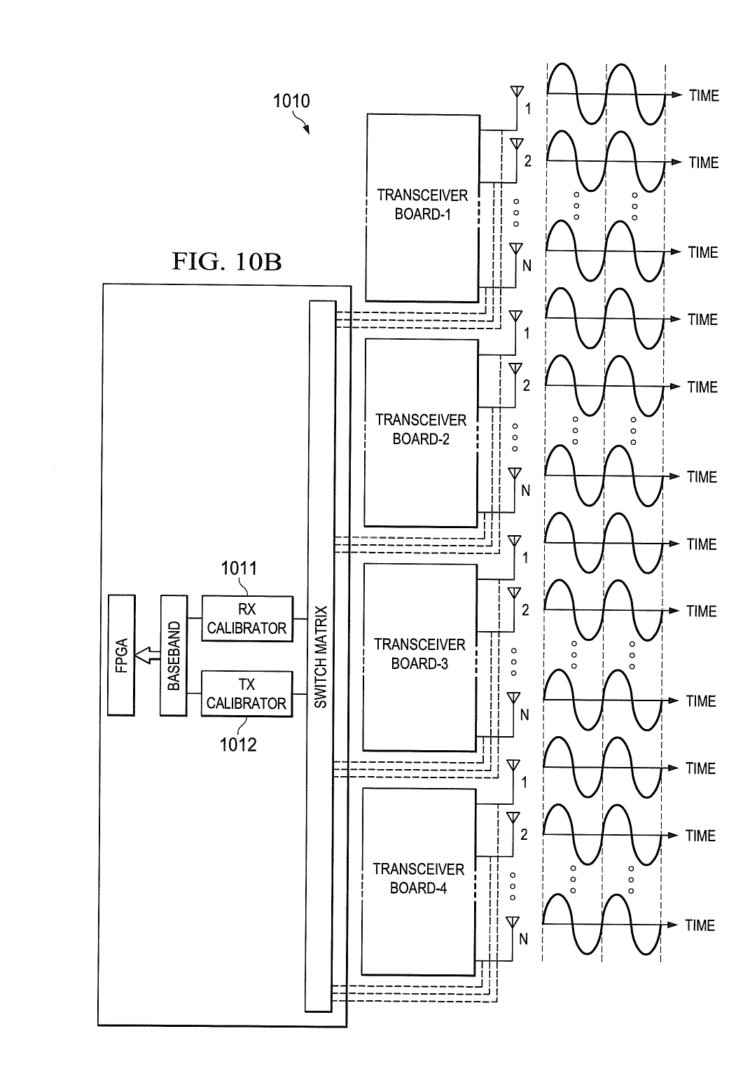

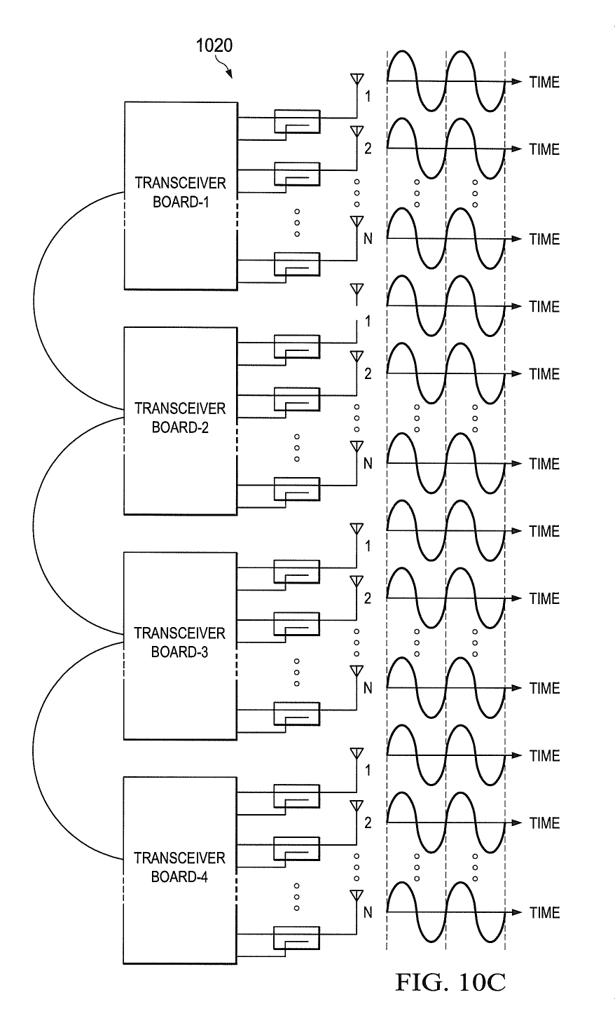

FIGS. 10A through 10C illustrate example multi-board antenna arrays in accordance with this disclosure. In particular, FIG. 10A illustrates a multi-board antenna array 1000 without calibration between boards and the resulting phase misalignment between boards that occurs after individual board calibration. FIG. 10B illustrates a method of achieving multi-array calibration using an additional board with a calibration circuit and phase-matched cables between the calibration circuit and other antenna arrays.

In FIG. 10A, a multi-board antenna array 1010 with a calibration circuit is shown. Even after each single board itself has aligned its RX or TX channels for its own antennas, there can be still misalignments between boards. Therefore, in one method, the phase and/or delay between each board can be aligned by group shifting the phase and/or delay of TX or RX channels for all of the antennas of each board.

In FIG. 10B, the multi-board antenna array 1010 includes a common feedback RX calibrator 1011 and a common feedback TX calibrator 1012 on a separate board to align time and phase delays of multiple boards. This approach adds extra cost and size to a system, as well as expensive phase-matched cabling or a way to attach all four boards to the calibration board where the feedback lines are phase-matched.

In FIG. 10C, a multi-board antenna array 1020 is implemented in accordance with this disclosure and overcomes the requirement for an additional calibration board that otherwise adds considerable size and cost to the system. Here, each board is connected to one or more other boards in accordance with this disclosure. The multi-board antenna array 1020 is calibrated between boards by two stages. For calibration, every two boards of the multi-board array are connected to one another through, for example, a coaxial cable or other connection. During the first stage, the calibration circuits of each single board are calibrated with respect to time and phase such that each board's calibration receivers and transmitters have the same delay and phase. Once the calibration circuits are calibrated, each board individually calibrates its RX and TX channels in time and phase during the second stage. The net result is that every board in the array can have an identical calibration circuit since the circuits have been cross-calibrated, and therefore each board in the array achieves the same delay and phase in every RX and TX channel after individual board calibrations have been run.

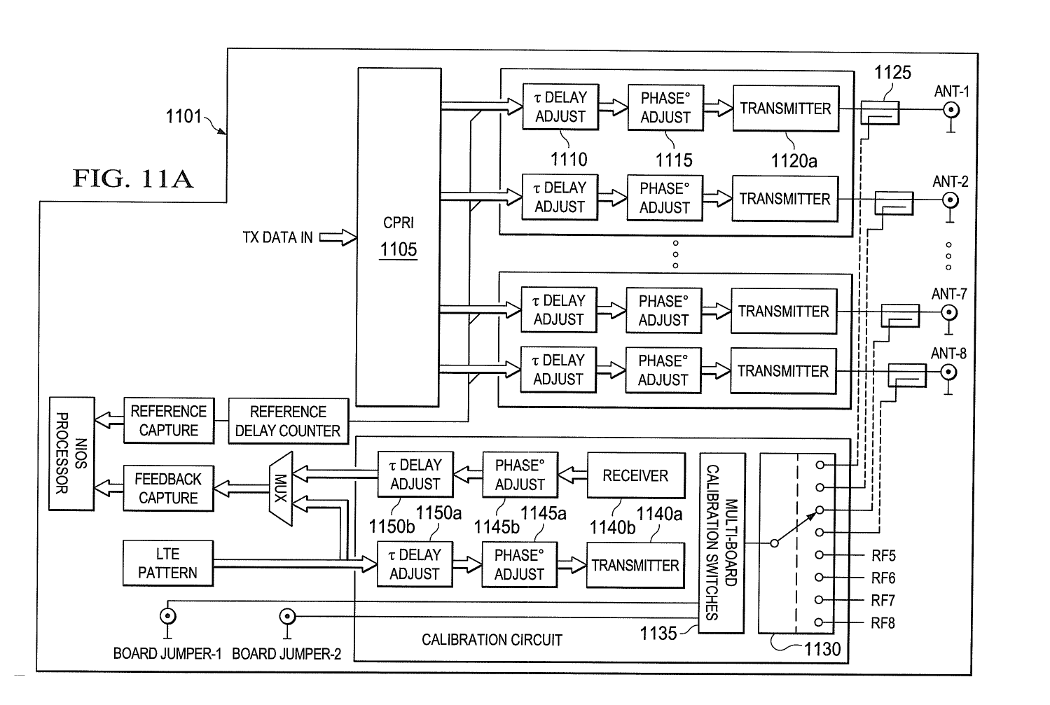

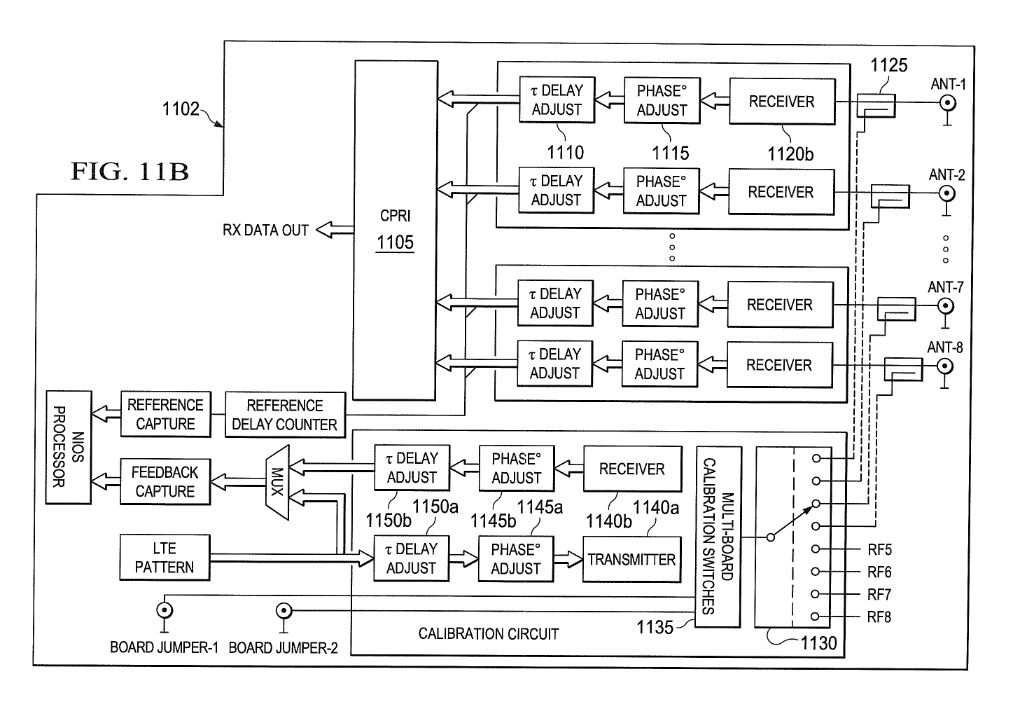

FIGS. 11A and 11B illustrate example single-board antenna arrays 1101-1102 with transmitter and receiver functions in accordance with this disclosure. In particular, FIG. 11A illustrates a single-board antenna array 1101 with eight transmitters, eight antennas, and a calibration circuit. FIG. 11B illustrates a single-board antenna array 1102 with eight receivers, eight antennas, and the same calibration circuit. Each calibration circuit can be responsible for (i) making accurate measurements of transmitter signals at each antenna element and (ii) injecting signals into the antenna elements and measuring them to mimic receiver antenna path responses. Therefore, each calibration circuit includes a calibration transmitter 1140a and a calibration receiver 1140b.

With reference to FIG. 11A, TX data entering into a Common Public Radio Interface (CPRI) 1105 splits to a baseband data capture system and into eight TX channels. Each TX channel includes a delay adjuster 1110 to compensate the delay of the TX signal and a phase adjuster 1115 to compensate the phase of the TX signal. Each adjusted TX signal proceeds to its respective transmitter 1120a and antenna for radiation. Couplers 1125 sample the TX signals from the antennas and provide feedback to switches 1130-1135, which selectively switch the sampled signals to the calibration receiver 1140b and into the baseband capture system. The baseband capture system simultaneously captures the TX input signal (REF) and calibration receiver feedback signal (FB). By measuring the time and phase differences between the sampled signals, it can align the delays and phases of all of the TX channels in the board by compensating for the differences using a phase adjuster 1115 and a delay adjuster 1110. The delay adjuster value is determined by an algorithm or function such as a cross-correlation, and the phase adjuster value is determined by an algorithm such as one that calculates the phase of a Fast Fourier Transform (FFT) applied to the reference and feedback data.

As shown in FIG. 11B, during the receive time, a reference baseband calibration signal is input into the calibration transmitter 1140a, passed through the multi-board calibration switches 1135, and selectively passed through the switch bank 1130 into the proper coupler 1125. There, it is backward wave coupled into the correct receiver path 1120b, where the signal is down-converted into baseband. The baseband capture system simultaneously captures the reference calibration signal and the feedback receiver signal. By calculating the time and phase differences between the sampled signals, it can align the delays and phases of all the RX channels in the board, compensating for the differences using a phase adjuster 1115 and delay adjuster 1110. As in the transmitter path, the delay adjuster value is determined by an algorithm or function such as a cross-correlation, and the phase adjuster value is determined by an algorithm such as one that calculates phase of an FFT applied to the reference and feedback data.

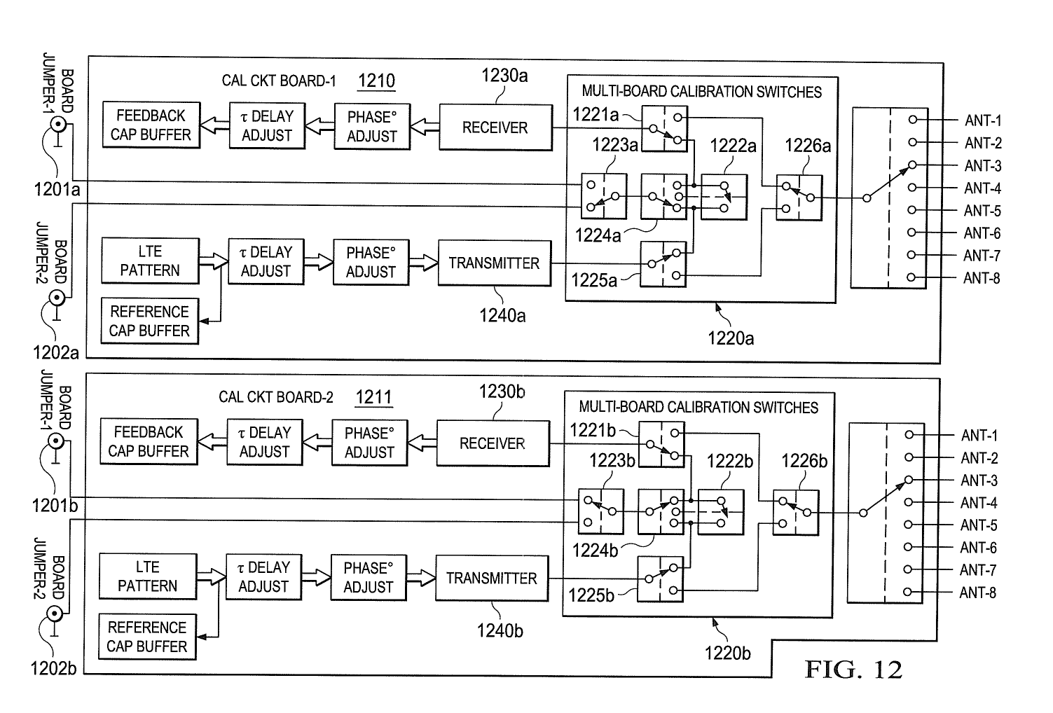

FIG. 12 illustrates an example of two connected boards with their associated calibration circuits among a multi-board antenna array in accordance with this disclosure. By connecting two calibration circuits together, it is possible to make four measurements between the two calibration circuits and determine the exact delay and phase differences between calibration receivers 1230a-1230b and calibration transmitters 1240a-1240b. This allows every calibration circuit on each board to be adjusted to obtain the exact same delay and phase as the other calibration circuits, thereby enabling multi-board phased array calibration.

The boards include jumpers 1201a-1201b and 1202a-1202b. Calibration switches 1220a of board 1210 include a network of switches 1221a-1226a, and calibration switches 1220b of board 1211 include a network of switches 1221b-1226b. The networks of calibration switches can form an inter-board (long) path, where a transmitter 1240a of board 1210 is connected to a receiver 1230b of board 1211 through switches 1223a-1225a and board jumper 1202a on board 1210 and jumper 1201b and switches 1221b, 1223b, 1224b on board 1211. Likewise, the receiver 1230a on board 1210 can be connected to the transmitter 1240b of board 1211. The networks of calibration switches can also form an intra-board (short) path, where the transmitter 1240a of board 1210 is connected to the receiver 1230a of board 1210 through switches 1221a, 1222a, 1225a. Likewise, the transmitter 1240b of board 1211 can be connected to the receiver 1230b of board 1211. Additionally, after the calibration circuits have been calibrated, the multi-board calibration switches 1220a-1220b can act as a pass-thru to allow the local calibration receiver and calibration transmitter to directly access and calibrate the board's own antenna paths via the multi-way switch (an eight-way antenna switch in this example).

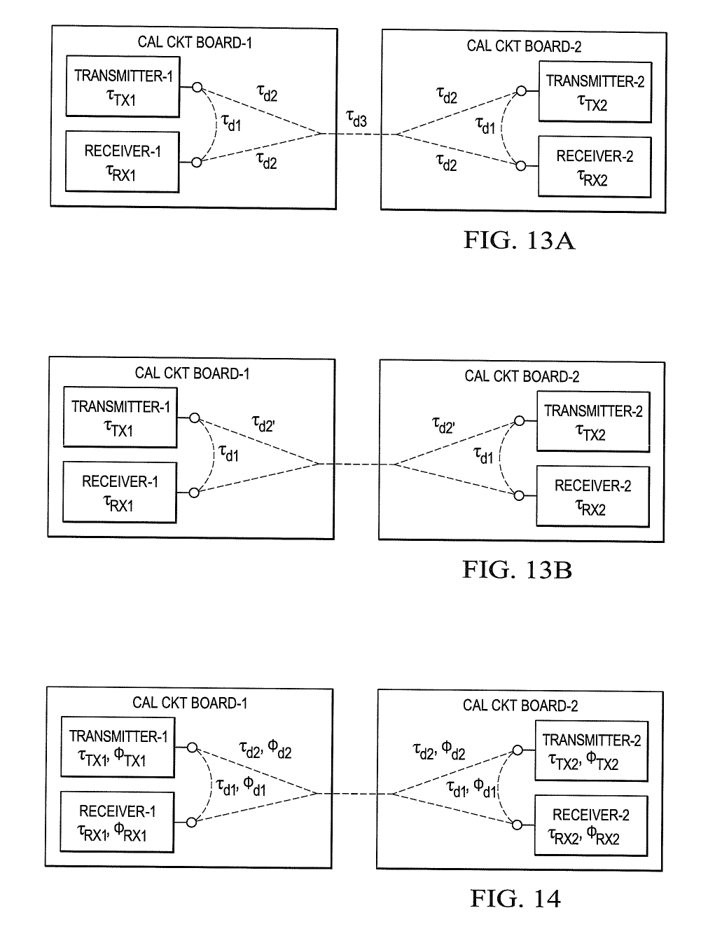

FIGS. 13A and 13B illustrate an example simplified calibration architecture for a two-board antenna array for deriving calibration equations in accordance with this disclosure. Since a cable connecting two boards represents a common point, its delay τ_{d3} can be lumped into a symmetrical line delay τ_{d2} to become τ_{d2′}. FIG. 14 illustrate an example final simplified calibration architecture for a two-board antenna array in accordance with this disclosure. The goal is to find the unknown time delay difference and phase difference between the two boards' calibration transmitters and receivers as follows:

Δτ_{RX}=(τ_{RX2}−τ_{RX1}) and Δτ_{TX}=(τ_{TX2}+τ_{TX1}); and

ΔØ_{RX}=(Ø_{RX2}−Ø_{RX1}) and ΔØ_{RX}=(Ø_{TX2}−Ø_{TX1})

For the two-board system, there are the following unknowns:

τ_{TX1},τ_{TX2},τ_{RX1},τ_{RX2},τ_{d1},τ_{d2}; and

Ø_{TX1},Ø_{TX2},Ø_{RX1},Ø_{RX2},Ø_{D1},Ø_{d2}.

Since there is symmetry in the paths, the delays and phases of the common paths can end up cancelling out and further reduce the number of unknowns by two. Mathematics indicates that a system of N linear equations is used to solve for N unknown values, so four unknown values can require four equations to solve for the unknowns.

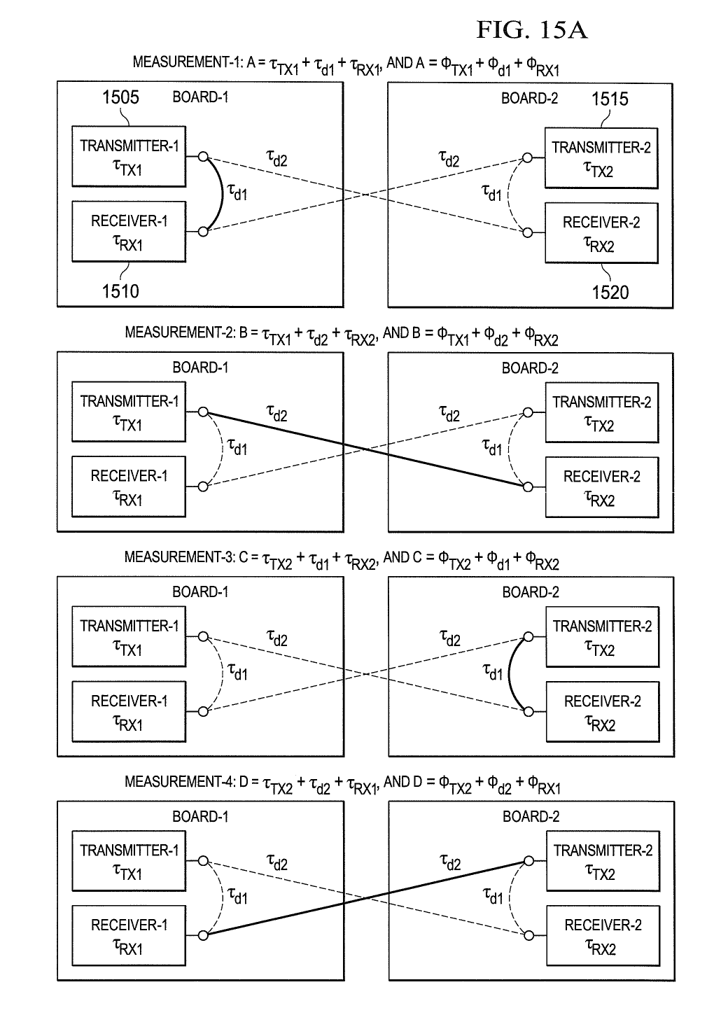

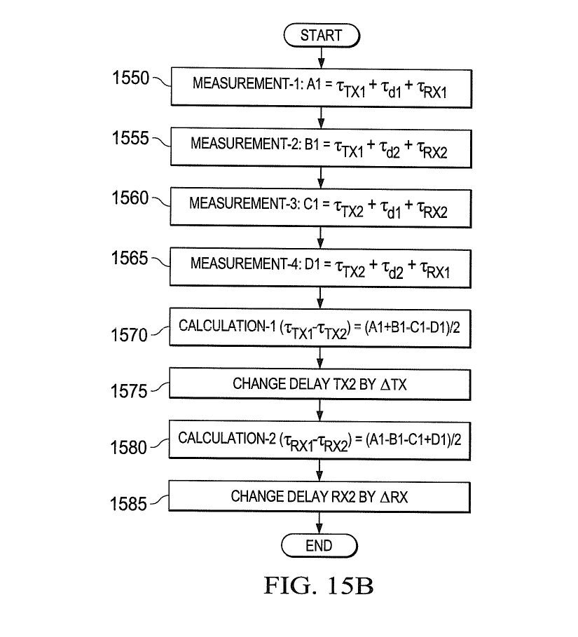

FIGS. 15A and 15B illustrate an example calibration operation for time delays of multi-board calibration circuits in accordance with this disclosure. With reference to FIGS. 15A and 15B, the calibration operation for a time delay is described. For calibration, every two boards of a multi-board antenna array are connected to one another through, for example, a coaxial cable. Between two connected boards, a calibration (CAL) transmitter 1505 of one board can be connected to a CAL receiver 1520 of the other board and a CAL receiver 1510 of one board can be connected to a CAL transmitter 1515 of the other board according to the operation of the CAL switch networks.

In some embodiments, determining the time delay difference Δτ_{TX} between the CAL transmitters of the connected boards and the time delay difference Δτ_{RX} between the CAL receivers of the connected boards uses four measurements:

1) Measure of delay A1 from Transmitter-1 on Board-1 to Receiver-1 on Board-1;
2) Measure of delay B1 from Transmitter-1 on Board-1 to Receiver-2 on Board-2;
3) Measure of delay C1 from Transmitter-2 on Board-2 to Receiver-2 on Board-2; and
4) Measure of delay D1 from Transmitter-2 on Board-2 to Receiver-1 on Board-1.

Here, A1, B1, C1 and D1 can be expressed as follows:

A1=τ_{TX1}+τ_{d1}+τ_{RX1}

B1=τ_{TX1}+τ_{d2}+τ_{RX2}

C1=τ_{TX1}+τ_{d1}+τ_{RX2}

D1=τ_{TX2}+τ_{d2}+τ_{RX1}

where τ_{TX1} and τ_{RX1} are the time delays at the transmitter 1505 and the receiver 1510, respectively, τ_{d1} is a time delay between the transmitter 1505 and the receiver 1510 on board 1, and τ_{d2} is a time delay between the transmitter 1505 on board 1 and the receiver 1520 on board 2 or between the receiver 1510 on board 1 and the transmitter 1515 on board 2. Operations 1550-1565 in FIG. 15B show the four measurement results and the parameters τ_{TX1}, τ_{RX1}, τ_{TX2}, τ_{RX2}+τ_{d1} and τ_{d2} that are lumped together in the results. From A1, B1, C1 and D1, the time delays between the CAL receivers 1510 and 1520 can be derived as follows:

(B1−−A1)=[τ_{TX1}+τ_{d2}+τ_{RX2}]−[τ_{TX1}+τ_{d1}+τ_{RX1}]=τ_{d2}−τ_{d1}+τ_{RX1}+τ_{RX2} (1)

(D1−C1)=[τ_{TX2}+τ_{d2}+τ_{RX1}]−[τ_{TX2}+τ_{d1}+τ_{RX2}]=τ_{d2}−τ_{d1}+τ_{RX1}+τ_{RX2} (2)

(B1−A1)−(D1−C1)=[τ_{d2}−τ_{d1}−τ_{RX1}+τ_{RX2}]−[τ_{d2}+τ_{RX1}+τ_{RX2}]=−2τ_{RX1}+2τ_{RX2} (3)

In operation 1570 of FIG. 15B, simplifying Equation (3) yields the time delay difference Δτ_{RX} between the CAL receivers 1510 and 1520 as follows:

Δτ_{RX}=τ_{RX2}−τ_{RX1}=(B1−A1−D1+C1)/2 (4)

In operation 1575, the CAL receiver 1520 of board 2 is calibrated by compensating the CAL adjust circuit of board 2 by Δτ_{RX}. Also, the time delay difference between the CAL transmitters 1505 and 1515 can be derived as follows:

(C1−A1)=[τ_{TX2}+τ_{d1}+τ_{RX2}]−[τ_{TX1}+τ_{d1}+τ_{RX1}]=τ_{TX2}−τ_{TX1}+(τ_{RX2}+τ_{RX1})=τ_{TX2}−τ_{TX1}+(B1−A1−D1+C1)/2 (5)

In operation 1580 of FIG. 15B, simplifying Equation (5) yields the time delay difference Δτ_{TX} between the CAL transmitters 1505 and 1515 as follows:

τ_{TX}=τ_{TX2}−τ_{TX1}=(C1−A1)−[(B1−A1−D1+C1)/2]=(−A1−B1+C1+D1)/2 (6)

In operation 1585, the CAL transmitter 1515 of board 2 is calibrated by compensating the CAL adjust circuit by Δτ_{TX}.

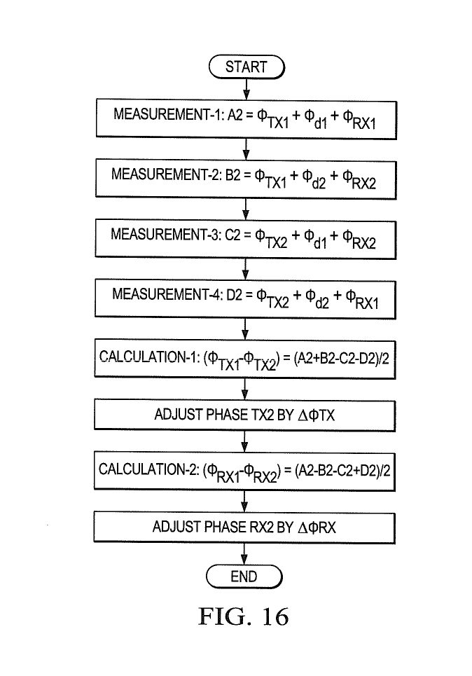

FIG. 16 illustrates an example calibration operation for phase delays of multi-board calibration circuits in accordance with this disclosure. In a similar way to calibrating the time delays, calibrating the phase delays between calibration circuits of two connected boards begins with making the four measurements described previously and defining A2, B2, C2 and D2 as follows:

A2=Ø_{TX1}+Ø_{d1}+Ø_{RX1}

B2=Ø_{TX1}+Ø_{d2}+Ø_{RX2}

C2=Ø_{TX1}+Ø_{d1}+Ø_{RX2}

D2=Ø_{TX2}+Ø_{d2}+Ø_{RX1}

where Ø_{TX1} and Ø_{RX1} are phase delays at the transmitter 1505 and the receiver 1510, respectively, Ø_{d1} is a phase delay between the transmitter 1505 and receiver 1510 on board 1, and Ø_{d2} is an inter-board phase delay between the transmitter 1505 on board 1 and the receiver 1520 on board 2 or between the receiver 1510 on board 1 and the transmitter 1515 on board 2. Values for A2, B2, C2 and D2 defined above can be determined by measuring Ø_{TX1}, Ø_{RX1}, Ø_{TX2}, Ø_{RX2}, Ø_{d1} and Ø_{d2}, which are known from making the four measurements.

From A2, B2, C2 and D2, the phase delay between the receiver calibration circuits of board 1 and board 2 can be derived from the measurements as follows:

(B2−A2)=[Ø_{TX1}+Ø_{d2}+Ø_{RX2}]−[Ø_{TX1}+Ø_{d1}+Ø_{RX1}]=Ø_{d2}−Ø_{d1}−Ø_{RX1}+Ø_{RX2} (7)

(D2−C2)=[Ø_{TX2}+Ø_{d2}+Ø_{RX1}]−[Ø_{TX2}+Ø_{d1}+Ø_{RX2}]=Ø_{d2}−Ø_{d1}−Ø_{RX1}−Ø_{RX2} (8)

(B2−A2)−(D2−C2)=[Ø_{d2}−Ø_{d1}−θ_{RX1}+θ_{RX2}]−[Ø_{d2}−Ø_{d1}+Ø_{RX1}−Ø_{RX2}]=−2Ø_{RX1}+2Ø_{RX2} (9)

Simplifying Equation (9) yields the phase delay difference ΔØ_{RX} between the receiver calibration circuits of boards 1 and 2 as follows:

ΔØ_{RX}=Ø_{RX2}−Ø_{RX1}=(B2−A2−D2+C2)/2 (10)

Also, the phase delay difference between the transmitter calibration circuits of boards 1 and 2 can be derived as follows:

(C2−A2)=[Ø_{TX2}+Ø_{d1}+Ø_{RX2}]−[Ø_{TX1}+Ø_{d1}+Ø_{RX1}]=Ø_{TX2}−Ø_{TX1}+(Ø_{RX2}−Ø_{RX1})=Ø_{TX2}−Ø_{TX1}+(B2−A2−D2+C2)/2. (11)

Simplifying Equation (11) yields the inter-board phase delay difference ΔØ_{TX} between transmitter calibration circuits as follows:

ΔØ_{TX}=Ø_{TX2}−Ø_{TX1}=(C2−A2)−[(B2−A2−D2+C2)/2]=(−A2−B2+C2+D2)/2 (12)

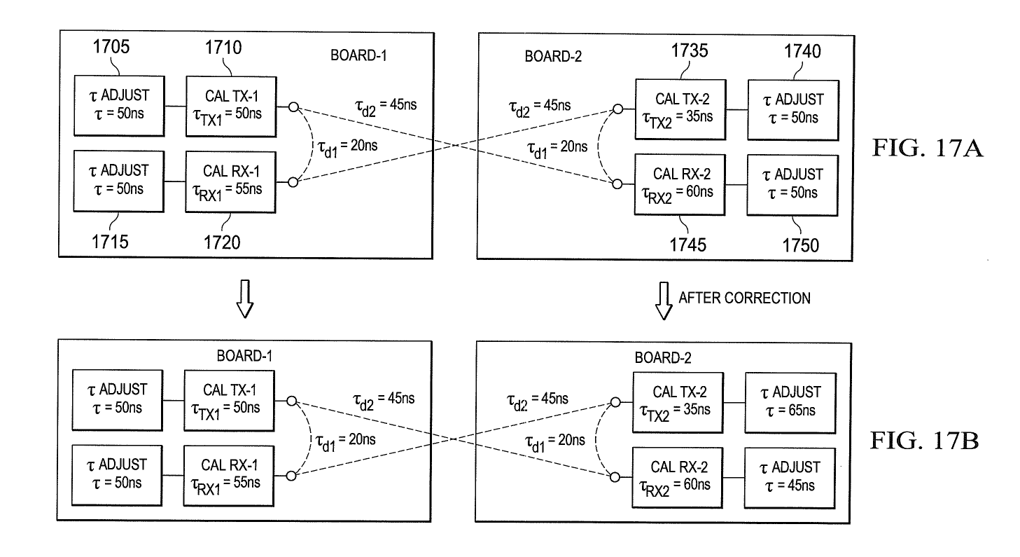

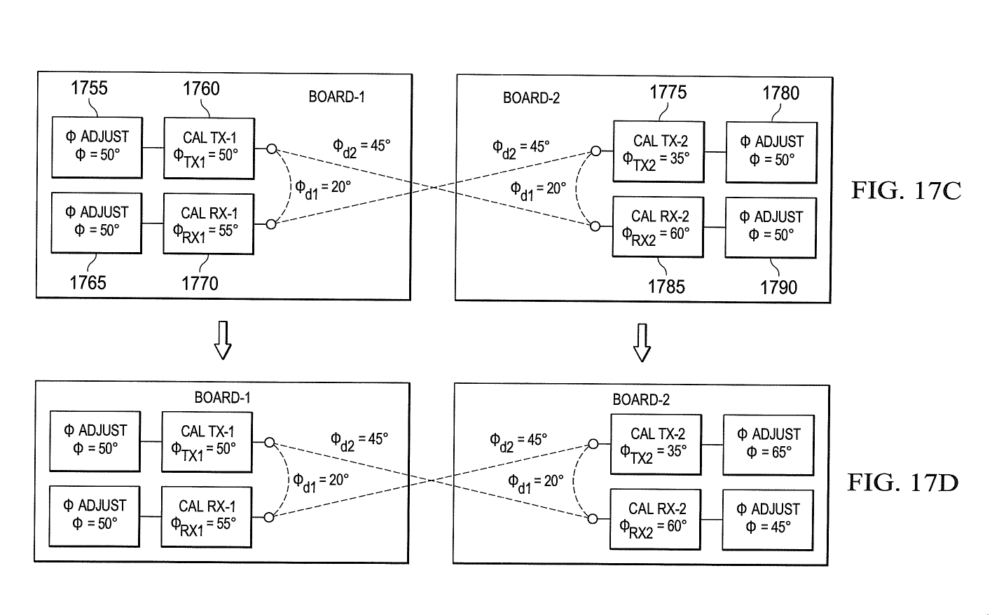

FIGS. 17A through 17D illustrate example calibrations of delays and phases between calibration circuits of two connected boards of a multi-board antenna array in accordance with this disclosure. Note that each board of the multi-board array is connected to at least one other board. In this example, boards 1 and 2 are assumed to be connected. The following calibration operations can also be implemented between other connected boards of a multi-board antenna array.

As shown in FIGS. 17A and 17B, a controller has made four measurements and from these measurements has calculated the time delays of transmitter calibrators 1710 and 1735, τ_{TX1} and τ_{TX2}, respectively. In addition, it is known that a CAL TX adjustor 1705 has a time adjusting values of τ_{adjTX1} and a CAL TX adjustor 1740 has a time adjusting values of τ_{adjTX2}.

By way of example only, the initial values for calibration circuits of the connected two boards, board 1 and board 2, are assumed as follows:

τ_{adjTX1}=50 ns,τ_{TX1}=50ns,τ_{adjTX2}=50ns,τ_{TX2}=35 ns

τ_{adjRX1}=50 ns,τ_{RX1}=50ns,τ_{adjRX2}=50ns,τ_{RX2}=35 ns

τ_{d1}=20 ns,τ_{d2}=45 ns

After setting the initial values as above, the calibration operation makes four measurements and obtains the A1, B1, C1, and D1 values as follows: A1=225 ns, B1=255 ns, C1=215 ns, and D1=235 ns. The time delay differences are calculated from Equations (4) and (6) as follows:

(τ_{TX2}−τ_{TX1})=(−A−B+C+D)/2

(τ_{RX2}−τ_{RX1})=(B−A−D+C)/2

Thus:

Δτ_{TX}=(τ_{TX2}+τ_{TX1})=15 ns

Δτ_{RX}=(τ_{RX2}−τ_{RX1})=−5 ns.

For calibrating the calibration circuit of board 2, the initial adjustment value of 50 ns for TX adjustor 1740 is adjusted by the amount Δτ_{TX} of +15 ns to be 65 ns. Also, to compensate for Δτ_{RX}, the initial adjustment value of 50 ns for an RX adjustor 1750 (coupled to a receiver calibrator 1745) is adjusted by the amount Δτ_{RX} of −5 ns to be 45 ns.

As shown in FIGS. 17C and 17D, similar to calibrating the time delay, the controller makes four measurements and determines the phase delay differences between transmitter calibrators 1760 and 1775, Δφ_{TX1} and Δφ_{TX2}, respectively. Also, the controller measures and determines the phase delay difference Δφ_{RX} between the receiver calibrator 1760 on board 1 and a receiver calibrator 1785 (coupled to an RX adjustor 1790) on board 2. In addition, it is known that a CAL TX adjustor 1755 has a phase adjusting values of φ_{adjTX1} and a CAL TX adjustor 1780 has a time adjusting values of φ_{adjTX2}.

By way of example only, the initial values for calibration circuits of the connected two boards, board 1 and board 2, are assumed as follows:

φ_{TX1}=50 deg,φ_{adjTX2}=50 deg,φ_{TX2}=35 deg,φ_{adjRX1}=50 deg

φ_{RX1}=55 deg,φ_{adjRX2}=50 deg,φ_{RX2}=60 deg,φ_{adjTX1}=50 deg

φ_{d1}=20 deg,φ_{d2}=45 deg

After setting the initial values as above, the calibration operation makes four measurements and obtains the A2, B2, C2, and D2 values as follows: A2=225 deg, B2=255 deg, C2=215 deg, D2=235 deg. The phase delay differences are calculated from Equations (10) and (12) as follows:

(φ_{RX2}−φ_{RX1})=(B−A−D+C)/2,(φ_{TX2}−φ_{TX1})=(−A−B+C+D)/2 (13)

Simplifying Equation (13) yields the inter-board phase delay difference ΔØ_{TX} between transmitter calibration circuits as follows:

Δτ_{TX}=(τ_{TX2}−τ_{TX1})=15 ns,Δτ_{RX}=(τ_{RX2}−τ_{RX1})=−5 ns

For calibrating the calibration TX channel on board 2 with respect to that of board 1, the initial adjustment value of 50 ns for the TX adjustor 1780 is adjusted by the amount Δτ_{TX} of +15 ns to be 65 ns. Also, for calibrating the calibration RX channel on board 2 with respect to that of board 1, the initial adjustment value of 50 ns for the RX adjustor 1750 is adjusted by the amount Δφ_{RX} of −5 ns to be 45 ns.

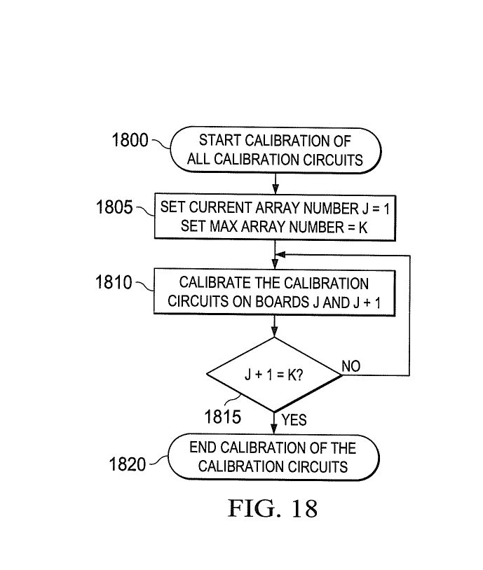

FIG. 18 is an example flowchart 1800 for calibrating a multi-board antenna array in accordance with this disclosure. Once the CAL transmitters and CAL receivers on different boards have the same delays, all of the TX and RX channels on each board can be aligned to have equal delays. To be an aligned multi-board, each of the TX and RX antenna channels has the same time delay and absolute phase.

In operation 1805, default values are set, which includes setting the current antenna array number=1 and setting the maximum number of arrays=K. In operation 1810, the calibration circuit (RX and TX) on boards 1 and 2 are calibrated to have identical delay and phase, such as by using the procedures previously described in FIGS. 15B and 16. In operation 1815, the algorithm checks to see if the current array J and its adjacent board (J+1) are the last boards requiring calibration circuit correction. If so, the process ends at step 1820 and moves on to calibration of the actual antenna arrays.

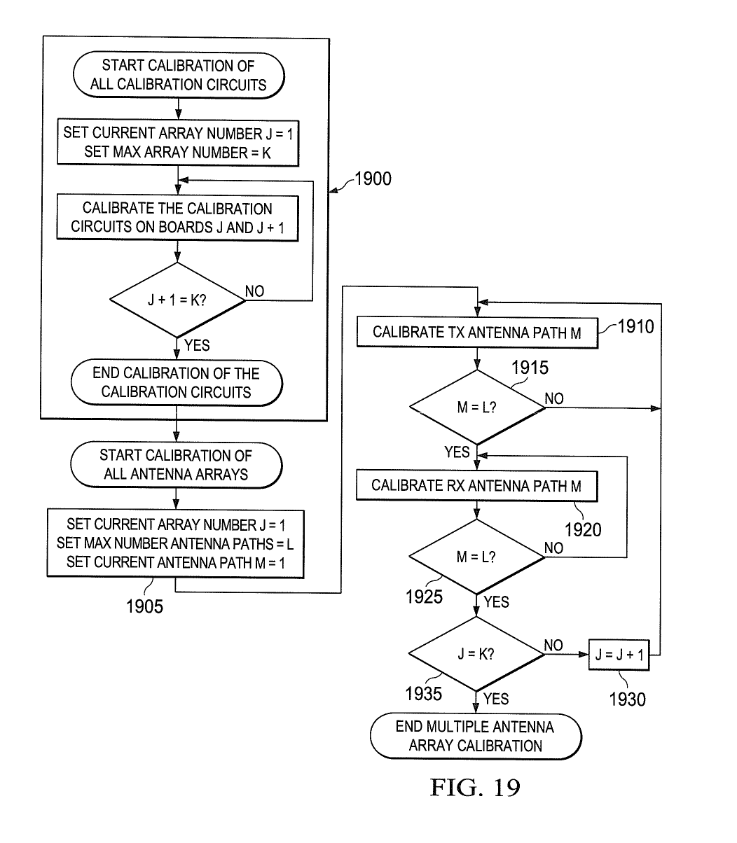

FIG. 19 illustrates an example time and phase calibration procedure for a multi-board antenna array in accordance with this disclosure. Once again, the multi-board antenna array includes at least two boards (board 1 and board 2) connected to one another.

The method for calibrating or correcting the calibration circuits (Calibration TX and Calibration RX) of a multi-board antenna array is performed in sub-routine 1900 prior to calibrating the main transmitter and receiver paths of each antenna array in the system. The sub-routine 1900 here represents the algorithm 1800 described above. Upon completion of the calibration circuit corrections, the process of calibrating the full array begins. In step 1905, default values are set, such as by setting the current antenna array number J=1, the maximum number of TX and RX antenna paths=L, and the current antenna path=M.

In steps 1910 and 1915, delay and phase calibrations are iteratively performed on each transmitter antenna path until all paths have the same envelope delay and RF carrier phase at each antenna port. This process was described previously in relation to FIG. 11A.

In steps 1920 and 1925, delay and phase calibrations are iteratively performed on each receiver antenna path until all paths have the same envelope delay and RF carrier phase at the receiver's baseband input (ADC). This process was described previously in relation to FIG. 11B.

In step 1935, the RX and TX calibrations are completed for the current array, so a check is made to see if the current array J is the last array K. If not, the array number J is incremented in step 1930, and the process returns to step 1910 to begin calibrating the transmitter and receiver paths of the next array. When the current array J is the last array K, the calibration of all antenna arrays in the system has been completed. At this point, all arrays have the same delay and phase relationships relative to each other since the calibration circuits on each board have been forced to have identical delay and phase.

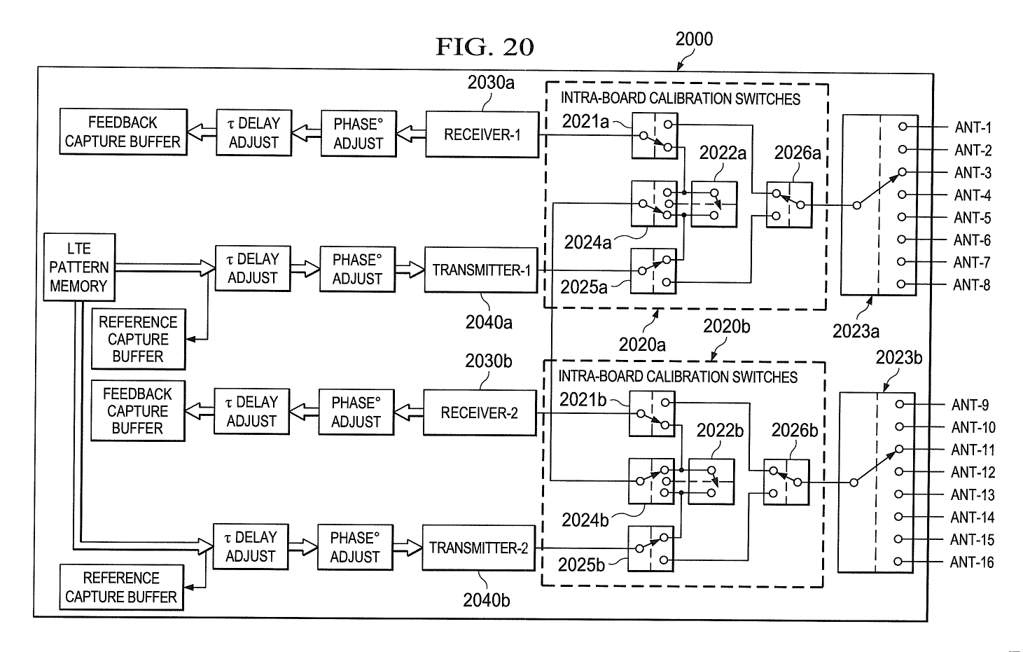

FIG. 20 illustrates an example system 2000 for self-calibrating two calibration receiver channels and two calibration transmitter channels in a single board of a multi-board antenna array in accordance with this disclosure. This configuration may be used, for example, when the phase correction algorithm uses baseband phase comparators to simultaneously determine the difference between two or more antenna paths.

In some beamforming systems, each antenna transmits the same data and waveform, and it is therefore possible to use a baseband phase comparator to calculate the phase difference between two or more antennas simultaneously. In such systems, two or more separate calibration circuits such as those described in FIG. 20 can be used. However, since different calibration transmitters 2040a-2040b and calibration receivers 2030a-2030b in such a system have different amplitude, delay and phase responses, each calibration circuit can be calibrated before use during a calibration routine. Further, each calibration circuit can have the capability to be auto-calibrated during normal operation to account for component changes, such as those caused by temperature and environmental influences and long-term drift. The calibration operations can be implemented by a controller installed on a single board of a multi-board antenna array or by a controller installed on an independent motherboard accommodating the multi-board antenna array or other board.

The system 2000 in FIG. 20 uses two identical switch banks 2023a-2023b to enable simultaneous antenna phase comparisons and allow faster calibrations compared to methods that calibrate one channel at a time. However, as previously mentioned, this approach can be limited to applications that transmit or receive identical data on all channels, which is typically not a cellular system that exhibits random traffic data on each channel.

FIG. 20 is nearly identical to FIG. 12 except for minor modifications that eliminate the off-board connectors, as well as the cables and switches that support that function. This example is given to show that the architecture of FIG. 12 that supports calibration of multi-board calibration circuits can easily be modified to support the calibration of multiple same-board calibration circuits. Furthermore, anytime there are two or more transmitters or receivers in a system where it is desired to know the delay difference and phase difference between them, the architectures in FIGS. 12 and 20 can be used along with the algorithm in FIGS. 15B and 16.

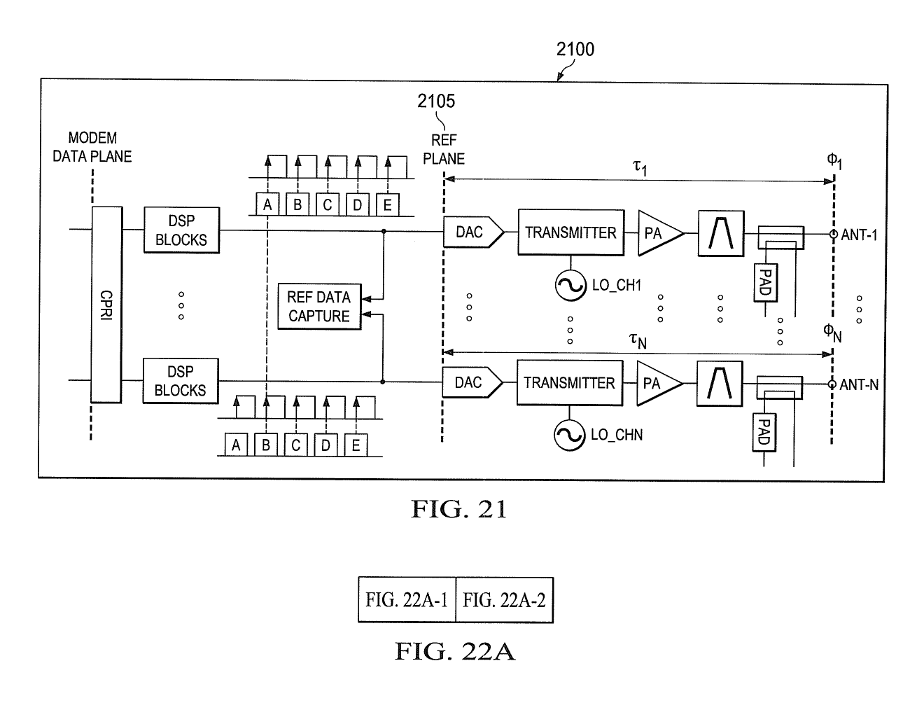

FIG. 21 illustrates an example clock synchronization plane 2100 used to calibrate an antenna array in accordance with this disclosure. In order to calibrate TX channels so that all TX channels exhibit the same envelope and carrier phase alignment at the antenna and all RX channels exhibit the same envelope and carrier phase alignment at the ADC output, the clock and data is aligned for every channel at the baseband REF plane where the reference data is captured (and later compared to the feedback data in order to calibrate delay and phase coefficients). Since the data from multi-channel modems becomes skewed after traversing long fiber or copper interfaces to an antenna array, clock synchronization is used at every channel's reference data capture plane (usually the DAC and ADC) in order to create a fixed reference plane where the data and clock are perfectly aligned (synchronized) across channels.

In the example below, the modem data and clock at the CPRI interface has become misaligned between channels. Even though it is possible through calibration to get equal delay (τ₁=τ₂= . . . τₙ) and equal phase alignment (φ₁=φ₂= . . . φₙ) between the REF plane and the antenna ports for all channels, the data at the REF plane is different channel-to-channel and therefore will show up at the antenna ports misaligned to each other or be sent to the modem misaligned relative to each other. This gives the impression of a bad calibration even though calibration has properly occurred. In order to generate an aligned signal, clock synchronization is performed at each channel's analog-to-digital converter (ADC) plane and digital-to-analog converter (DAC) plane in order to create a fixed reference plane where data is substantially aligned (synchronized) with the clock. This is referred to as the REF synchronization plane 2105.

Digital clocks can be auto-calibrated (synchronized) by buffering a sample of each clock at the respective DAC/ADC inputs and sending these clock samples across matched length traces to a clock phase detector. Software or other logic can determine the phase adjustment required for each clock and program each clock's individual delay. All clocks can originate from the same clock integrated circuit, which can have an adjustable delay capability on all clocks outputs. With the clocks and data synchronized at the REF plane, delay phase differences between multiple transmitter and receiver paths can easily be calibrated using baseband delay blocks to create an end-to-end array calibration.

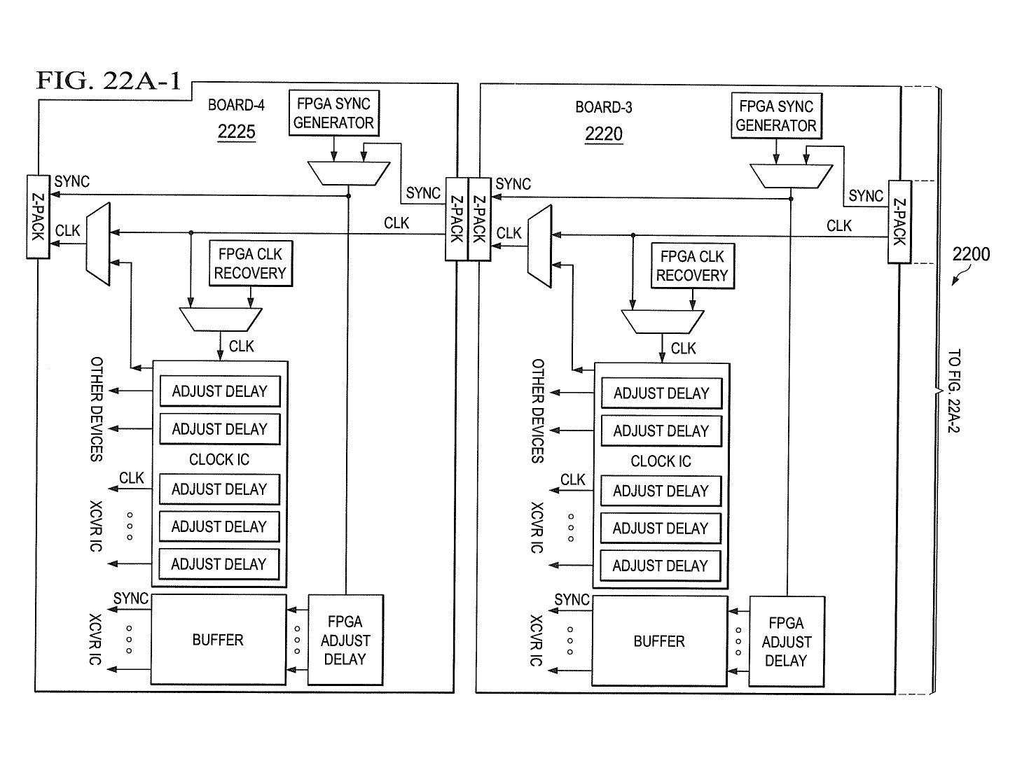

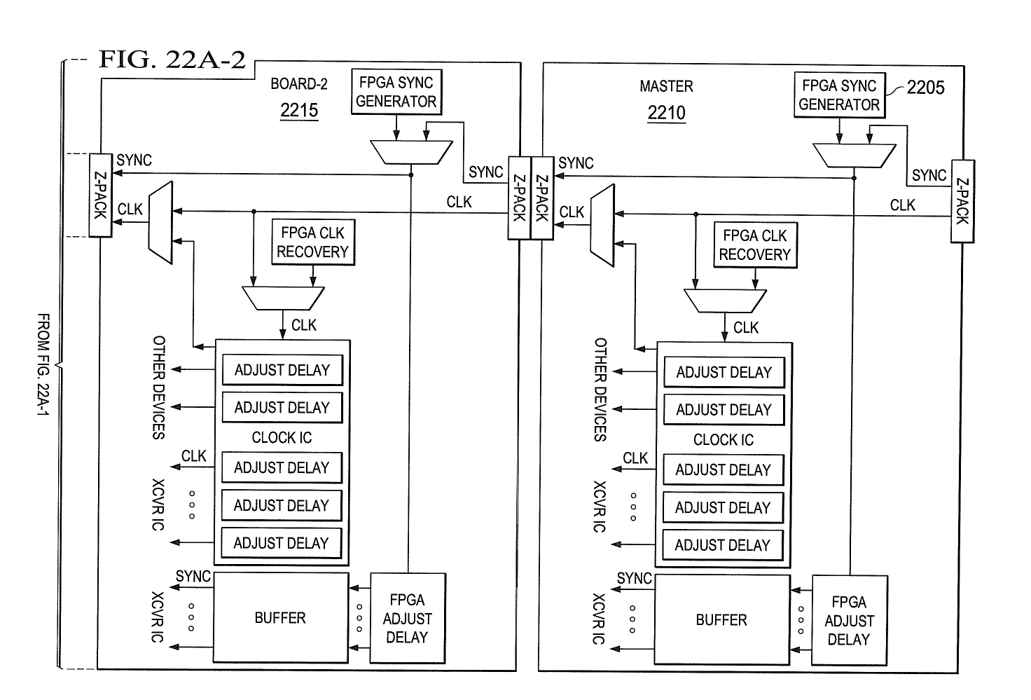

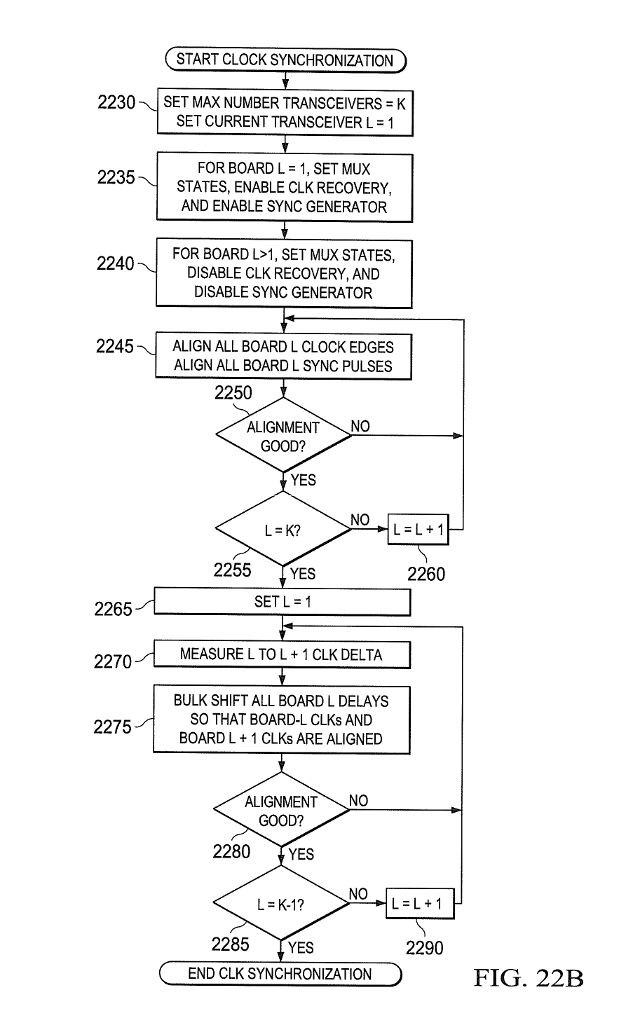

FIG. 22A illustrates an example multi-board antenna array 2200 with a clock synchronization system and FIG. 22B illustrates an example algorithm for achieving clock synchronization across multiple antenna arrays in accordance with this disclosure. Identical transceiver boards can be used in the multi-board antenna array 2200, although a master board can be designated to receive a system clock, synchronize to the system clock, and distribute the system clock to other boards. In some embodiments, the system clock can be input into a Z-pack backplane connector from an external clock, or it can be recovered from a CPRI interface using an FPGA SERDES (such as ALTERA's GTX gigabit transceivers). A system sync signal can be input from an external source or derived in the master board's FPGA or controller. Modem transceiver integrated circuits often use a sync signal to periodically synchronize clock and data signals.

Each board in the array can include clock delay adjustment capabilities. Modern clock distribution integrated circuits often have this capability built-in to the devices. A synchronized delay can be performed in an FPGA or controller. To do this, each board can have CLK and Sync inputs and outputs to pass signals along to other boards.

A clock synchronization operation in accordance with this disclosure can occur as follows. The clock synchronization operation can be used on up to N boards, but this example shows four boards for simplicity. In step 1, one of the boards is designated to be the master board 2210, and the other boards 2215-2225 are designated to be slave boards. In step 2, on the master board 2210, a controller 2205 enables a clock recovery circuit, enables a sync generator circuit, and sets three multiplexers to the correct settings. In step 3, on the slave boards 2215-2225, the controller 2205 disables a clock recovery circuit, disables a sync generator circuit, and sets three multiplexers to the correct settings. In step 4, the controller 2205 on the master board 2210 injects a synchronization (sync) pulse into the master board 2210 and uses the master board's sync pulse generator circuit. In step 5, the controller 2205 on the master board 2210 injects a clock at the normal clock frequency into the master board 2210 or recovers the clock from a clock recovery circuit. In step 6, on the master board 2210, the controller 2205 adjusts the phase of the Clock and Sync signals arriving at each transceiver path so that all transceiver Clock and Sync inputs arrive substantially edge-aligned. This can be auto-synchronized as described above using a clock phase comparator. In step 7, on each slave board 2215-2225, the controller 2205 adjusts the phase of the Clock and Sync signals arriving at each transceiver path so that all transceiver Clock and Sync inputs arrive substantially edge-aligned. This can be auto-synchronized as in step 6. In step 8, on board 2220, the controller 2205 adjusts all Clock and Sync delays on the board 2220 to match the Clock and Sync phases of the board 2225, which could be auto-synchronized as in step 6. In step 9, on board 2215, the controller 2205 adjusts all Clock and Sync delays on the board 2215 to match the Clock and Sync phases of the board 2225, which could be auto-synchronized as in step 6. In step 10, on board 2210, the controller 2205 adjusts all Clock and Sync delays on the board 2210 to match the Clock and Sync phases of the board 2225, which could be auto-synchronized as in step 6.

With reference to FIG. 22B, it is noted that each antenna array has a built-in radio transceiver with the number of receiver and transmitter paths equal to the number of antenna ports. In step 2230, default values are set, such as by setting the maximum number of transceiver boards=K (equal to the number of antenna arrays) and the current transceiver board=1. In step 2235, designate the master as board #1 and set the multiplexer (MUX) states such that the Sync generator will be used by the local FPGA and also propagated to the other boards in the system. Also, enable (turn on) the clock recovery circuit (to recover a clock from the modem data), set the MUX to correct state, and enable the sync generator. In step 2240, for all other transceiver boards in the system, set the MUX states to obtain the sync and clock signals from the backplane, turn off the Sync generator, and turn off the clock recovery circuit. In step 2245, align all of the master board's clock edges and align all the Sync pulses. This can be done manually or automatically as previously described. In step 2250, check to see if the alignment is good, such as either visually using an oscilloscope or automatically using a phase comparator and suitable algorithm. If alignment is bad, step 2245 is repeated. If alignment is good, a check is made in step 2255 if L equals K. If no, increment L in step 2260 and return to step 2245.

After all K boards have had their clocks and Sync pulses aligned, each board is still in misalignment with respect to the other boards. So, in step 2265, set the current board equal to the master L=1 and measure the clock edge difference between boards L and L+1 in step 2270. This can be done visually with an oscilloscope or automatically using a phase comparator and suitable algorithm. In step 2275, use the clock edge delta found in step 2270 and apply a bulk shift of all clocks on the current board to put them in alignment with the clocks on board L+1. This process continues via steps 2280-2290 to put all board clocks in alignment with each other. Since the Sync pulse is orders of magnitude slower than the clock, it may not need bulk shifting, although that is an option that can be performed in steps 2270-2290.

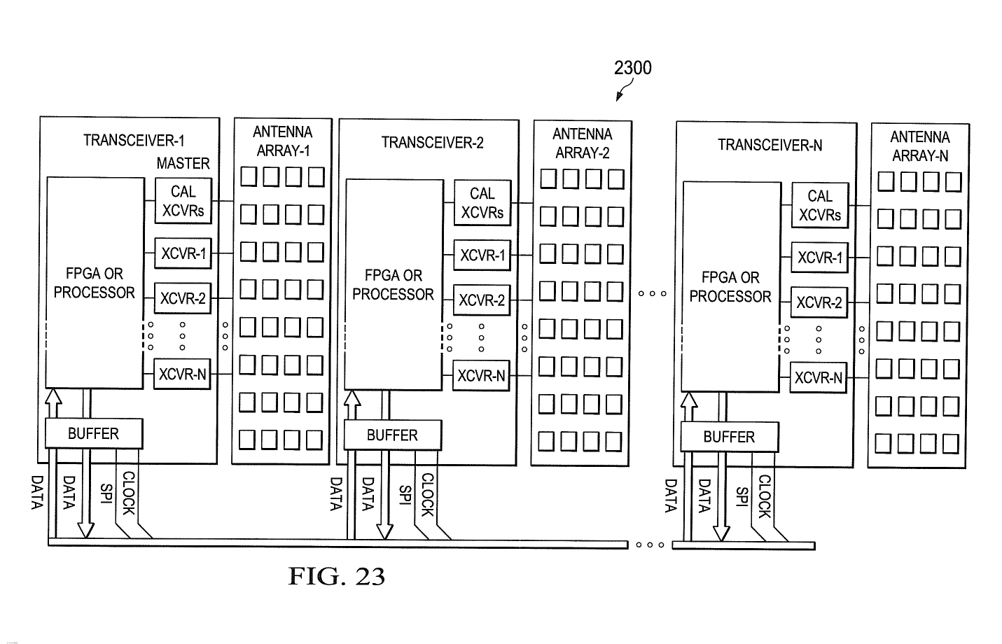

FIG. 23 illustrates an example multi-board antenna array 2300 equipped with a data transfer system in accordance with this disclosure. When multiple boards and transceivers require calibration, a method of transferring calibration commands and data between individual boards can be used. For example, a system with four individual antenna arrays (where each array has 32 elements) can achieve beamforming phase alignment between the 32 elements of each array, but there may be no phase alignment between the four arrays.

A method of communication between individual antenna and transceiver boards can be used to accomplish beamforming calibration between all boards. A communication system can include buffered low-voltage differential signaling (LVDS) data input lines, data output lines, clock lines, and SPI lines running between every transceiver board in the system. One of the transceiver boards can be designated as the master board, and the master board can configure all other boards to be slaves and issue read and write commands to each transceiver to request or send data.

One example use of this system is to share beamforming calibration data between each board, and the master board can enable a bulk phase shift of each antenna array so that all antenna arrays become phase aligned. It is assumed that each antenna array has all of its 32 antenna elements phase aligned, but the arrays are not phase aligned to each other. The master board can perform a calibration of its first antenna element-1 with the first antenna element-1 of the next array (antenna array-2), such as by using the communication system to compare the phases of each element. The resulting phase difference can be applied to all 32 elements of the next array-2. This process can be repeated for the remaining antenna arrays (array-3 through array-N) so that all antenna arrays have substantially the same RF phase alignment at every antenna element.

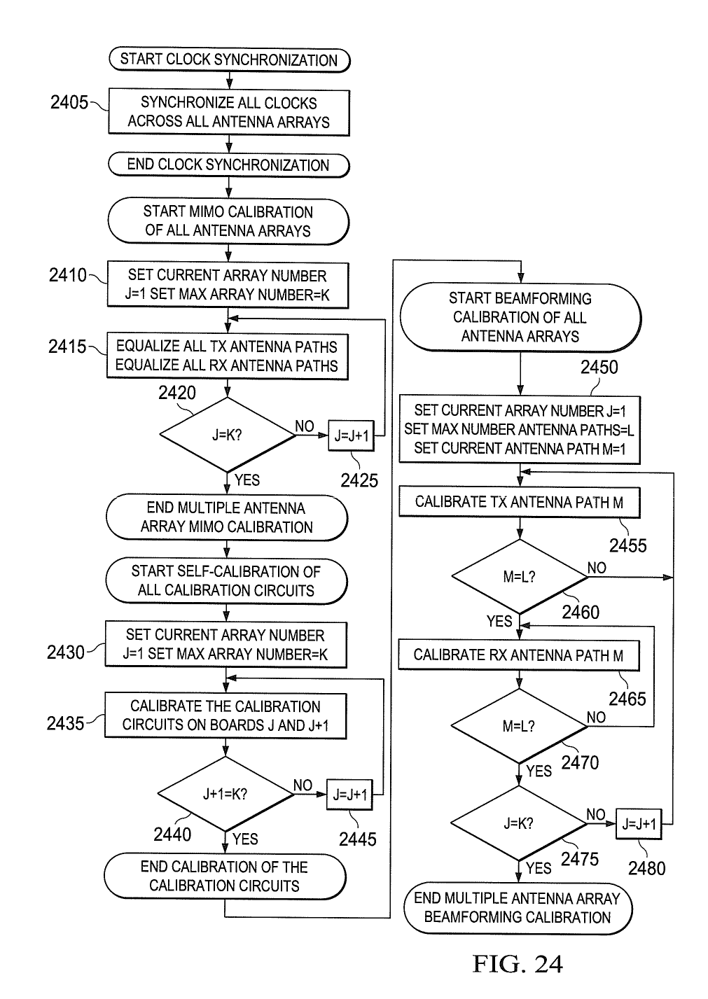

FIG. 24 illustrates an example flowchart describing calibration operations of multi-board antenna arrays in accordance with this disclosure. In the following discussion, the calibration system is used with K antenna arrays (each with N antenna elements) connected to N transceiver cards, where each antenna array is typically connected to one transceiver card such that K=N. The calibration operations can be divided into four stages: (i) clock synchronization, (ii) MIMO calibration (equalization), (iii) calibrating the calibration circuit on each board, and (iv) beamforming calibration of multiple antenna arrays to each other.

In step 2405, the calibration operation synchronizes all clocks on every board to each other, such as by using the architecture, algorithm, and flowchart previously described in FIGS. 22A and 22B. Upon completion of clock synchronization, the calibration operation performs MIMO calibration on all antenna arrays. This involves equalization of the amplitude responses and phase responses of all TX and RX paths in the array to achieve wireless channel reciprocity as described previously in FIG. 5. In step 2410, the calibration operation sets default values, such as by setting the current array J=1 and the maximum number of arrays=K. In step 2415, the calibration operation equalizes all transmitter and receiver paths, such as by using the algorithm and flowchart of FIG. 5. The calibration operation checks to see if the current array is the last array in step 2420. If not, the current array J is incremented in step 2425, and the process returns to step 2415.

After MIMO calibration has completed, the calibration operation moves on to self-calibration of the calibration circuits. This enables delay and phase calibration between all antenna ports in a multi-board antenna array system. In step 2430, the calibration operation sets default values, such as by setting the current antenna array J=1 and the maximum number of arrays=K. In step 2435, the calibration operation self-calibrates the calibration circuits on two adjacent boards J and J+1, such as by using the hardware described in FIG. 12 and the flowchart and algorithms described in FIGS. 15B, 16 and 18. In step 2440, the calibration operation checks to see if the calibration operation is on the last set of boards in the system. If not, the calibration operation increments J at step 2445 and returns to step 2435. This continues until all calibration circuits on all boards have been calibrated to make τ_{CAL}_{_{—}}_{TX}_{_{—}}_{Array1}=τ_{CAL}_{_{—}}_{TX}_{_{—}}_{Array2}= . . . =τ_{CAL}_{_{—}}_{TX}_{_{—}}_{ArrayK}, φ_{CAL}_{_{—}}_{TX}_{_{—}}_{Array1}=φ_{CAL}_{_{—}}_{TX}_{_{—}}_{Array2}= . . . =φ_{CAL}_{_{—}}_{TX}_{_{—}}_{ArrayK}, τ_{CAL}_{_{—}}_{TX}_{_{—}}_{Array1}=τ_{CAL}_{_{—}}_{TX}_{_{—}}_{Array2}= . . . =τ_{CAL}_{_{—}}_{TX}_{_{—}}_{ArrayK}, and φ_{CAL}_{_{—}}_{TX}_{_{—}}_{Array1}=φ_{CAL}_{_{—}}_{TX}_{_{—}}_{Array2}= . . . =φ_{CAL}_{_{—}}_{TX}_{_{—}}_{ArrayK}. When this condition is met, it is possible to perform beamforming calibration on K individual antenna arrays and expect every RX and TX antenna path on every array to have delay and phase alignment at the antenna port for TX and delay and phase alignment at the receiver baseband (ADC output).

Beamforming array calibration begins with step 2450 where default values are set, such as by setting the current array number J=1, the maximum number of antenna paths=L, and the current antenna path M=1. In step 2455, the calibration operation performs beamforming calibration on the current TX antenna path, such as by using the algorithm and method described in association with FIG. 11A. In step 2460, the calibration operation checks to see if beamforming calibration has completed on all TX antenna paths in the array. If not, the calibration operation repeats step 2455 after incrementing M until all TX paths are calibrated. In step 2465, the calibration operation performs beamforming calibration on the current RX antenna path, such as by using the algorithm and method described with respect to FIG. 11B. In step 2470, a check is made to see if beamforming calibration has completed on all RX antenna paths in the array. If not, the calibration operation repeats step 2465 after incrementing M until all RX paths are calibrated. In step 2475, the calibration operation checks to see if the current array is the last array. If not, the current array J is incremented at step 2480 and the process returns to step 2455.

To summarize, this disclosure provides various methods and apparatuses for calibrating a multi-board antenna array supporting MIMO and/or beamforming. This disclosure also provides a clocking system for multiple-board antenna array synchronization, as well as techniques for automatic compensation of a calibration circuit itself (which can be calibrated before being used to calibrate the antenna arrays). This disclosure further provides a communication system that enables the calibration of a plurality of antenna arrays. In addition, this disclosure provides an algorithm for performing multiple antenna array calibration that ties together clock synchronization, calibration of a calibration circuit, auto-calibration of each antenna path per antenna array, and auto-calibration of each antenna array to each other.

Note that various functions described in this patent document can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
transmitting a calibration command to multiple antenna arrays, each antenna array comprising a plurality of antenna elements, a plurality of transmitter and receiver channels, and a calibration circuit comprising a calibration receiver and a calibration transmitter, the antenna arrays connected to one another;
for each pair of connected antenna arrays, calibrating the calibration circuits of the connected antenna arrays based on time delay differences and phase delay differences between the calibration receivers and the calibration transmitters in the pair of connected antenna arrays; and
calibrating the antenna elements of each antenna array using the calibrated calibration circuits.

2. The method of claim 1, further comprising:
calibrating each antenna array to have substantially a same time delay and substantially a same phase delay at respective antenna ports.

3. The method of claim 1, wherein a coaxial cable connects the calibration circuits of each pair of connected antenna arrays.

4. The method of claim 1, wherein the calibration circuit of each antenna array comprises a network of switches configured to form one of:
an inter-antenna array path connecting the calibration receiver of one antenna array to the calibration transmitter of another antenna array; and
an intra-antenna array path connecting the calibration receiver and the calibration transmitter of one antenna array.

5. The method of claim 1, wherein the time delay difference between the calibration receivers in one pair of connected antenna arrays is determined as:
τ_{RX2}−τ_{RX1}=(B1−A1−D1+C1)/2
where:
A1=τ_{TX1}+τ_{d1}+τ_{RX1}
B1=τ_{TX1}+τ_{d2}+τ_{RX2}
C1=τ_{TX1}+τ_{d1}+τ_{RX2}
D1=τ_{TX2}+τ_{d2}+τ_{RX1}
wherein τ_{TX1} and τ_{RX1} are time delays at the calibration transmitter and the calibration receiver, respectively, in a first of the connected antenna arrays;
wherein τ_{TX2} and τ_{RX2} are time delays at the calibration transmitter and the calibration receiver, respectively, in a second of the connected antenna arrays;
wherein τ_{d1} is a time delay between the calibration transmitter and the calibration receiver in the first antenna array; and
wherein τ_{d2} is a time delay between the calibration transmitter in one of the connected antenna arrays and the calibration receiver in another of the connected antenna arrays.

6. The method of claim 5, wherein the time delay difference between the calibration transmitters in one pair of connected antenna arrays is determined as:
(τ_{TX2}−τ_{TX1})=(−A1−B1+C1+D1)/2.

7. The method of claim 1, wherein the phase delay difference between the calibration receivers in one pair of connected antenna arrays is determined as:
Ø_{RX2}−Ø_{RX1}=(B2−A2−D2+C2)/2
where:
A2=Ø_{TX1} Ø_{d1}+Ø_{RX1}
B2=Ø_{TX1} Ø_{d2}+Ø_{RX2}
C2=Ø_{TX1} Ø_{d1}+Ø_{RX2}
D2=Ø_{TX2}+Ø_{d2}+Ø_{RX1}
wherein Ø_{TX1} and Ø_{RX1} are phase delays at the calibration transmitter and the calibration receiver, respectively, in a first of the connected antenna arrays;
wherein Ø_{TX2} and Ø_{RX2} are phase delays at the calibration transmitter and the calibration receiver, respectively, in a second of the connected antenna arrays;
wherein Ø_{d1} is a phase delay between the calibration transmitter and the calibration receiver in the first antenna array; and
wherein Ø_{d2} is a phase delay between the calibration transmitter in one of the connected antenna arrays and the calibration receiver in another of the connected antenna arrays.

8. The method of claim 7, wherein the phase delay difference between the calibration transmitters in one pair of connected antenna arrays is determined as:
(Ø_{TX2}−Ø_{TX1})=(−A2−B2+C2+D2)/2.

9. The method of claim 1, further comprising:
measuring a first time delay in the transmitter and receiver channels of a first of the multiple antenna arrays using the calibrated calibration circuit in the first antenna array;
measuring a second time delay in the transmitter and receiver channels of a second of the multiple antenna arrays using the calibrated calibration circuit in the second antenna array;
calculating a difference between the first time delay and the second time delay; and
adjusting the channels of one of the first and second antenna arrays based on the calculated difference.

10. The method of claim 1, further comprising:
measuring a first phase delay in the transmitter and receiver channels of a first of the multiple antenna arrays using the calibrated calibration circuit in the first antenna array;
measuring a second phase delay in the transmitter and receiver channels of a second of the multiple antenna arrays using the calibrated calibration circuit in the second antenna array;
calculating a difference between the first phase delay and the second phase delay; and
adjusting the channels of one of the first and second antenna arrays based on the calculated difference.

11. A system comprising multiple antenna arrays, each antenna array comprising:
a plurality of antenna elements;
a plurality of transmitter and receiver channels;
a calibration circuit comprising a calibration receiver and a calibration transmitter; and
a controller configured to:
calibrate the calibration circuit of the antenna array based on time delay differences and phase delay differences between the calibration receivers and the calibration transmitters in a pair of connected antenna arrays; and
calibrate the antenna elements of the antenna array using the calibrated calibration circuit of the antenna array.

12. The system of claim 11, wherein the controllers in the multiple antenna arrays are collectively configured to calibrate the antenna arrays to have substantially a same time delay and substantially a same phase delay at antenna ports of the antenna arrays.

13. The system of claim 11, wherein the calibration circuit in each antenna array comprises a network of switches configured to form one of:
an inter-antenna array path connecting the calibration receiver of one antenna array to the calibration transmitter of another antenna array; and
an intra-antenna array path connecting the calibration receiver and the calibration transmitter of one antenna array.

14. The system of claim 11, wherein each controller is configured to determine the time delay difference between the calibration receivers in one pair of connected antenna arrays as:
τ_{RX2} τ_{RX1}=(B1−A1−D1+C1)/2
where:
A1=τ_{TX1}+τ_{d1}+τ_{RX1}
B1=τ_{TX1}+τ_{d2}+τ_{RX2}
C1=τ_{TX1}+τ_{d1}+τ_{RX2}
D1=τ_{TX2}+τ_{d2}+τ_{RX1}
wherein τ_{TX1} and T_{RX1} are time delays at the calibration transmitter and the calibration receiver, respectively, in a first of the connected antenna arrays;
wherein τ_{TX2} and τ_{RX2} are time delays at the calibration transmitter and the calibration receiver, respectively, in a second of the connected antenna arrays;
wherein τ_{d1} is a time delay between the calibration transmitter and the calibration receiver in the first antenna array; and
wherein τ_{d2} is a time delay between the calibration transmitter in one of the connected antenna arrays and the calibration receiver in another of the connected antenna arrays.

15. The system of claim 14, wherein each controller is configured to determine the time delay difference between the calibration transmitters in one pair of connected antenna arrays as:
(τ_{TX2}−τ_{TX1})=(−A1−B1+C1+D1)/2.

16. The system of claim 11, wherein each controller is configured to determine the phase delay difference between the calibration receivers in one pair of connected antenna arrays as:
Ø_{RX2}−Ø_{RX1}=(B2−A2−D2+C2)/2
where
A2 Ø_{TX1}+Ø_{d1}+Ø_{RX1}
B2=Ø_{TX1}+Ø_{d2}+Ø_{RX2}
C2=Ø_{TX1}+Ø_{d1}+Ø_{RX2}
D2=Ø_{TX2}+Ø_{d2}+Ø_{RX1}
wherein Ø_{TX1} and Ø_{RX1} are phase delays at the calibration transmitter and the calibration receiver, respectively, in a first of the connected antenna arrays;
wherein Ø_{TX2} and Ø_{RX2} are phase delays at the calibration transmitter and the calibration receiver, respectively, in a second of the connected antenna arrays;
wherein Ø_{d1} is a phase delay between the calibration transmitter and the calibration receiver in the first antenna array; and
wherein Ø_{d2} is a phase delay between the calibration transmitter in one of the connected antenna arrays and the calibration receiver in another of the connected antenna arrays.

17. The system of claim 16, wherein each controller is configured to determine the phase delay difference between the calibration transmitters in one pair of connected antenna arrays as:
(Ø_{TX2}−Ø_{TX1})=(−A1−B1+C1+D1)/2.

18. The system of claim 11, wherein the controller in a first of the multiple antenna arrays or a second of the multiple antenna arrays is further configured to:
calculate a difference between a first time delay in the transmitter channel of the first antenna array and a second time delay in the transmitter channel of the second antenna array; and
adjust the channels of one of the first and second antenna arrays based on the calculated difference.

19. An apparatus for use with multiple antenna arrays, each antenna array comprising a plurality of antenna elements, a plurality of transmitter and receiver channels, and a calibration circuit comprising a calibration receiver and a calibration transmitter, the apparatus comprising:
a controller configured to:
calibrate the calibration circuit of a first of the multiple antenna arrays based on time delay differences and phase delay differences between the calibration receivers and the calibration transmitters in a pair of connected antenna arrays including the first antenna array and a second antenna array; and
calibrate the antenna elements of the first antenna array using the calibrated calibration circuit of the first antenna array.

20. The apparatus of claim 19, wherein the controller is configured to control a network of switches in the calibration circuit of the first antenna array to form one of:
an inter-antenna array path connecting one of the calibration transmitter or the calibration receiver of the first antenna array to one of the calibration receiver or the calibration transmitter of the second antenna array; and
an intra-antenna array path connecting the calibration receiver and the calibration transmitter of the first antenna array.

21. The apparatus of claim 19, wherein the controller is configured to determine the time delay difference between the calibration receivers of the first and second antenna arrays as:
τ_{RX2}−τ_{RX1}=(B1−A1−D1+C1)/2
where:
A1=τ_{TX1}+τ_{d1}+τ_{RX1}
B1=τ_{TX1}+τ_{d2}+τ_{RX2}
C1=τ_{TX}+τ_{d1}+τ_{RX2}
D1=τ_{TX2}+τ_{d2}+τ_{RX1}
wherein τ_{TX1} and T_{RX1} are time delays at the calibration transmitter and the calibration receiver, respectively, in the first antenna array;
wherein τ_{TX2} and τ_{RX2} are time delays at the calibration transmitter and the calibration receiver, respectively, in the second antenna array;
wherein τ_{d1} is a time delay between the calibration transmitter and the calibration receiver in the first antenna array; and
wherein τ_{d2} is a time delay between the calibration transmitter in one of the first and second antenna arrays and the calibration receiver in another of the first and second antenna arrays.

22. The apparatus of claim 21, wherein the controller is configured to determine the time delay difference between the calibration transmitters of the first and second antenna arrays as:
(τ_{TX2}−τ_{TX1})=(−A1−B1+C1+D1)/2.

23. The apparatus of claim 19, wherein the controller is configured to determine the phase delay difference between the calibration receivers of the first and second antenna arrays as:
Ø_{RX2}−Ø_{RX1}=(B2−A2−D2+C2)/2
where:
A2=Ø_{TX1}+Ø_{d1}+Ø_{RX1}
B2=Ø_{TX1}+Ø_{d2}+Ø_{RX2}
C2=Ø_{TX1}+Ø_{d1}+Ø_{RX2}
D2=Ø_{TX2}+Ø_{d2}+Ø_{RX1}
wherein Ø_{TX1} and Ø_{RX1} are phase delays at the calibration transmitter and the calibration receiver, respectively, in the first antenna array;
wherein Ø_{TX2} and Ø_{RX2} are phase delays at the calibration transmitter and the calibration receiver, respectively, in the second antenna array;
wherein Ø_{d1} is a phase delay between the calibration transmitter and the calibration receiver in the first antenna array; and
wherein Ø_{d2} is a phase delay between the calibration transmitter in one of the first and second antenna arrays and the calibration receiver in another of the first and second antenna arrays.

24. The apparatus of claim 22, wherein the controller is configured to determine the phase delay difference between the calibration transmitters of the first and second antenna arrays as:
(Ø_{TX2}+Ø_{TX1})=(−A1−B1+C1+D1)/2.

25. The apparatus of claim 19, wherein the controller is further configured to:
calculate a difference between a first time delay in the transmitter and receiver channels of the first antenna array and a second time delay in the transmitter channel of the second antenna array;
calculate a difference between a first phase delay in the transmitter and receiver channels of the first antenna array and a second phase delay in the transmitter channel of the second antenna array; and
adjust the channels of at least one of the first and second antenna arrays based on the calculated differences.

26. A method for aligning multiple transceivers connected to one another, each transceiver comprising a transmitter and a receiver, the method comprising:
transmitting an alignment command to the multiple transceivers; and
for each pair of connected transceivers, aligning calibration circuits of the connected transceivers based on time delay differences and phase delay differences between the receivers and the transmitters in the pair of connected transceivers;
wherein the time delay difference between the receivers in one pair of connected transceivers is determined as:
τ_{RX2}−τ_{RX1}=(B1−A1−D1+C1)/2
where:
A1=τ_{TX1}+τ_{d1}+τ_{RX1}
B1=τ_{TX1}+τ_{d2}+τ_{RX2}
C1=τ_{TX1}+τ_{d1}+τ_{RX2}
D1=τ_{TX2}+τ_{d2}+τ_{RX1}
wherein τ_{TX1} and τ_{RX1} are time delays at the transmitter and the receiver, respectively, in a first of the connected transceivers;
wherein τ_{TX2} and τ_{RX2} are time delays at the transmitter and the receiver, respectively, in a second of the connected transceivers;
wherein τ_{d1} is a time delay between the transmitter and the receiver in the first transceiver; and
wherein τ_{d2} is a time delay between the transmitter in one of the connected transceivers and the receiver in another of the connected transceivers.

27. The method of claim 26, wherein the time delay difference between the transmitters in one pair of connected transceivers is determined as:
(τ_{TX2}−τ_{TX1})=(−A1−B1+C1+D1)/2.

28. The method of claim 26, wherein the phase delay difference between the receivers in one pair of connected transceivers is determined as:
Ø_{RX2}−Ø_{RX1}=(B2−A2−D2+C2)/2
where:
A2=Ø_{TX1}+Ø_{d1}+Ø_{RX1}
B2=Ø_{TX1}+Ø_{d2}+Ø_{RX2}
C2=Ø_{TX1}+Ø_{d1}+Ø_{RX2}
D2=Ø_{TX2}+Ø_{d2}+Ø_{RX1}
wherein Ø_{TX1} and Ø_{RX1} are phase delays at the transmitter and the receiver, respectively, in the first transceiver;
wherein Ø_{TX2} and Ø_{RX2} are phase delays at the transmitter and the receiver, respectively, in the second transceiver;
wherein Ø_{d1} is a phase delay between the transmitter and the receiver in the first transceiver; and
wherein Ø_{d2} is a phase delay between the transmitter in one of the connected transceivers and the receiver in another of the connected transceivers.

29. The method of claim 28, wherein the phase delay difference between the transmitters in one pair of connected transceivers is determined as:
(Ø_{TX2}−Ø_{TX1})=(−A1−B1+C1+D1)/2.

30. An apparatus for aligning multiple transceivers connected to one another, each transceiver comprising a transmitter and a receiver, the apparatus comprising:
a controller configured to:
transmit an alignment command to the multiple transceivers; and
for each pair of connected transceivers, align calibration circuits of the connected transceivers based on time delay differences and phase delay differences between the receivers and the transmitters in the pair of connected transceivers;
wherein the controller is configured to determine the time delay difference between the receivers in one pair of connected transceivers as:
τ_{RX2}−τ_{RX1}=(B1−A1−D1+C1)/2
where:
A1=τ_{TX1}+τ_{d1}+τ_{RX1}
B1=τ_{TX1}+τ_{d2}+τ_{RX2}
C1=τ_{TX1}+τ_{d1}+τ_{RX2}
D1=τ_{TX2}+τ_{d2}+τ_{RX1}
wherein τ_{TX1} and τ_{RX1} are time delays at the transmitter and the receiver, respectively, in a first of the connected transceivers;
wherein τ_{TX2} and τ_{RX2} are time delays at the transmitter and the receiver, respectively, in a second of the connected transceivers;
wherein τ_{d1} is a time delay between the transmitter and the receiver in the first transceiver; and
wherein τ_{d2} is a time delay between the transmitter in one of the connected transceivers and the receiver in another of the connected transceivers.

31. The apparatus of claim 30, wherein the controller is configured to determine the time delay difference between the transmitters in one pair of connected transceivers as:
(τ_{TX2}−τ_{TX1})=(−A1−B1+C1+D1)/2.

32. The apparatus of claim 30, wherein the controller is configured to determine the phase delay difference between the receivers in one pair of connected transceivers as:
Ø_{RX2}−Ø_{RX1}=(B2−A2−D2+C2)/2
where:
A2=Ø_{TX1}+Ø_{d1}+Ø_{RX1}
B2=Ø_{TX1}+Ø_{d2}+Ø_{RX2}
C2=Ø_{TX1}+Ø_{d1}+Ø_{RX2}
D2=Ø_{TX2}+Ø_{d2}+Ø_{RX1}
wherein Ø_{TX1} and θ_{RX1} are phase delays at the transmitter and the receiver, respectively, in the first transceiver;
wherein θ_{TX2} and θ_{RX2} are phase delays at the transmitter and the receiver, respectively, in the second transceiver;
wherein θ_{d1} is a phase delay between the transmitter and the receiver in the first transceiver; and
wherein Ø_{d2} is a phase delay between the transmitter in one of the connected transceivers and the receiver in another of the connected transceivers.

33. The apparatus of claim 32, wherein the controller is configured to determine the phase delay difference between the transmitters in one pair of connected transceivers as:
(Ø_{TX2}−Ø_{TX1})=(−A1−B1+C1+D1)/2.

34. A method for use with multiple antenna arrays, each antenna array comprising a plurality of antenna elements, a plurality of transceivers, a clock recovery circuit, and a synchronization (sync) generator circuit, the method comprising:
designating one of the antenna arrays as a master antenna array and at least one other of the antenna arrays as at least one slave antenna array;
enabling the clock recovery circuit and the sync generator circuit of the master antenna array;
disabling the clock recovery circuits and the sync generator circuits of each slave antenna array;
injecting a clock signal recovered from the clock recovery circuit of the master antenna array into the master and at least one slave antenna arrays;
injecting a sync signal generated from the sync generator circuit of the master antenna array into the master and at least one slave antenna arrays;
adjusting phases of the clock and sync signals arriving at each transceiver in the master antenna array such that the clock and sync signals arrive substantially edge-aligned at each transceiver of the master antenna array; and
for each slave antenna array, adjusting phases of clock and sync signals arriving at each transceiver in the slave antenna array such that the clock and sync signals arrive substantially edge-aligned at each transceiver of the slave antenna array.

35. An apparatus for use with multiple antenna arrays, each antenna array comprising a plurality of antenna elements, a plurality of transceivers, a clock recovery circuit, and a synchronization (sync) generator circuit, the apparatus comprising:
a controller configured to:
designate one of the antenna arrays as a master antenna array and at least one other of the antenna arrays as at least one slave antenna array;
enable the clock recovery circuit and the sync generator circuit of the master antenna array;
disable the clock recovery circuits and the sync generator circuits of each slave antenna array;
inject a clock signal recovered from the clock recovery circuit of the master antenna array into the master and the at least one slave antenna arrays;
inject a sync signal generated from the sync generator circuit of the master antenna array into the master and the at least one slave antenna arrays;
adjust phases of the clock and sync signals arriving at each transceiver in the master antenna array such that the clock and sync signals arrive substantially edge-aligned at each transceiver of the master antenna array; and
for each slave antenna array, adjust phases of clock and sync signals arriving at each transceiver in the slave antenna array such that the clock and sync signals arrive substantially edge-aligned at each transceiver of the slave antenna array.
